(19) United States
(12) Patent Application Publication
(10) Pub. No.: US 2021/0055560 A1
(43) Pub. Date: Feb. 25, 2021

(54) COMPACT OPTICS IN CROSSED CONFIGURATION FOR VIRTUAL AND MIXED REALITY

(71) Applicant: Tesseland LLC, Pasadena, CA (US)

(72) Inventors: Pablo BENÍTEZ, Madrid (ES); Julio C. CHAVES, Coimbra (PT); Juan Carlos MIÑANO, Madrid (ES); Bharathwaj NARASIMHAN, Fremont, CA (US); Marina BULJAN, Madrid (ES); Milena NIKOLIC, Madrid (ES); Pablo ZAMORA, Madrid (ES); Dejan GRABOVICKIC, Madrid (ES)

(73) Assignee: Tesseland LLC, Pasadena, CA (US)

(21) Appl. No.: 16/959,517

(22) PCT Filed: Jan. 25, 2019
(86) PCT No.: PCT/US2019/015162

§ 371 Date: Jul. 1, 2020

Related U.S. Application Data
(60) Provisional application No. 62/622,525, filed on Jan. 26, 2018.

(51) Int. Cl. G02B 27/01; G02B 5/26; G02B 5/04

(52) U.S. Cl. CPC G02B 27/0172; G02B 27/0018; G02B 5/04; G02B 5/26

(57) ABSTRACT

A display device with one or more displays and an optical system with a plurality of channels arranged to generate an immersive virtual image from the a image, the virtual image comprising a plurality of image pixels, by each channel projecting light from the object pixels to a respective pupil range. The object pixels are grouped into clusters, each associated with a channel that produces from the object pixels a partial virtual image comprising image pixels. The clusters of at least two channels are substantially contained in opposite half-spaces defined by a plane passing by the imaginary sphere center. Each of the two channels comprises one surface on which the imaging light rays forming the partial virtual image suffer a last reflection before reaching the pupil range, where each surface is substantially contained in the opposite half-space containing their respective clusters.

### CROSS REFERENCE TO RELATED APPLICATIONS

This application contains subject matter related with PCT/US2014/067149 of Benitez et al. (“PCT1”) and PCT/US2016/014163 (“PCT6”) with inventors in common, which applications are incorporated herein by reference in their entireties. This application is also related to and claims priority from U.S. Provisional Application 62/622,525, filed Jan. 26, 2018, the disclosure of which is incorporated herein by reference in its entirety.

### FIELD OF THE INVENTION

The application relates to visual displays, and especially to head-mounted display technology.

### BACKGROUND

### References Cited

Rolland, J. P. “Wide angle, off-axis, see-through head-mounted display”. Opt. Eng. (Special Issue on Pushing the Envelope in Optical Design Software) 2000, 39, 1760-1767; (“Rolland”)
U.S. Pat. No. 5,526,183 by Chen, B. C.; and also Chen, B. C. “Wide field of view, wide spectral band off-axis helmet-mounted display optical design”, Proceedings of the International Optical Design Conference, Manhart, P. K., Sasian, J. M., Eds.; 2002; 4832(5); (“Chen 1”)
Droessler, J. G.; Rotier, D. J. “Tilted cat helmet mounted display”, Opt. Eng. 1995, 29 (8), 24-49 (“Droessler 1”)
U.S. Pat. No. 5,822,127 by Chen C. V et al. (“Chen 2)
U.S. Pat. No. 6,147,807 by Droessler, J. G. (“Droessler 2”)
U.S. Pat. No. 9,244,277 by Cheng, D., Wang, Y., Hua, H. (“Cheng”)
U.S. Pat. No. 9,729,232 by Hua, H., Gao, C. (“Hua”)
Wang et al. “The Light Field Stereoscope”, SIGGRAPH2015, (“Wang”)

Each of the forgoing is incorporated herein by reference in their entirety.

### 2. Definitions

| | |
|---|---|
| cluster | Set of active opixels that illuminates the pupil range through a |
| | given channel. The number of clusters is equal to the number of |
| | channels. If more than one display is used, each display can coincide |
| | with a cluster. |
| display | Component that modulates the light spatially to form an image. |
| | Currently available displays are mostly electronically operated, and are |
| | “digital” displays that generate an array of distinct pixels. The display |
| | can be self-emitting, such as an OLED display, or externally |
| | illuminated by a front or a backlight system, such as an LCD or an |
| | LCOS. The displays may be of the type called Light Field Displays |
| | (“Huang”) implemented by stacked (transmissive) LCDs. Particularly |
| | interesting because of its thickness is the case of just 2 stacked LCDs |
| | with a separator among them. Light Field Displays support focus cues |
| | which together with the rest of the device help to solve the vergence- |
| | accommodation conflict at a reasonable cost and volume. |
| eye pupil | Image of the interior iris edge through the eye cornea seen from the |
| | exterior of the eye. In visual optics, it is referenced to as the input pupil |
| | of the optical system of the eye. Its boundary is typically a circle from 3 |
| | to 7 mm diameter depending on the illumination level. |
| eye sphere | Sphere centered at the approximate center of the eye rotations and with |
| | radius the average distance of the eye pupil to that center (typically 13 |
| | mm). |
| field of view | Defined as the horizontal and vertical full angles subtended by the |
| (FOV) | virtual screen from the eye pupil center when the two eyes rest looking |
| | frontwards. |
| fixation point | Point of the scene that is imaged by the eye at center of the fovea, |
| | which is the highest resolution area of the retina and typically has a |
| | diameter of 1.5 mm. |
| gaze vector | Unit vector of the direction linking the center of the eye pupil and the |
| | fixation point. |
| gazed region of | Region of the virtual screen containing the fixation points for all |
| virtual screen | positions of the eye pupil within the union of the pupil ranges. It |
| | contains all the ipixels that can be gazed. |
| human angular | Minimum angle subtended by two point sources which are |
| resolution | distinguishable by an average perfect-vision human eye. The angular |
| | resolution is a function of the peripheral angle and of the illumination |
| | level. |
| imaging light | Ray trajectories used in the design that go from the opixel to the pupil |
| rays | range defining the ipixels on the virtual screen. |
| ipixel | Virtual image of the opixels belonging to the same web. Preferably, this |
| | virtual image is formed at a certain distance from the eye (from 2 m to |
| | infinity). It can also be considered as the pixel of the virtual screen seen |
| | by the eye. |
| channel | Each one of the individual optical paths, which collects light from the |
| | digital display and projects it to the eye sphere. The channel is designed |
| | to form a continuous image of opixels into ipixels. Each channel may |
| | be formed by one or more optical surfaces, either refractive or |
| | reflective. One surface may be used by one or more channels. There is |
| | one channel per cluster. |
| light filter | A surface whose optical characteristics (reflection, refraction, |
| | transmission, absorption) vary with the characteristics of the light |
| | (polarization, wavelength) incident upon it. |
| opixel | Physical pixel of the digital display. There are active opixels, which are |
| | lit to contribute to the displayed image, and inactive opixels, which are |
| | never lit. An inactive opixel can be physically nonexistent, for instance, |
| | because the display lacks at that opixel position at least one necessary |
| | hardware element (OLED material, electrical connection) to make it |
| | functional, or it can be unaddressed by software. The use of inactive |
| | opixels reduces the power consumption and the amount of information |
| | to be managed. |
| optical cross-talk | Undesired situation in which one opixel is imaged into more than one |
| | ipixel. |
| outer region of | Region of the virtual screen formed by the ipixels which do not belong |
| virtual screen | to the gazed region of virtual screen, i.e., it is formed by ipixels that can |
| | be seen only at peripheral angles greater than zero. |
| peripheral angle | Angle formed by a certain direction and the gaze vector. |
| pupil range | 1. Region of the eye sphere illuminated by a single cluster through its |
| | corresponding lenslet. When the eye pupil intersects the pupil range of |
| | a given lenslet, then the image corresponding to its corresponding |
| | cluster is projected on the retina. For a practical immersive design, a |
| | pupil range comprising a circle of 15 degrees full angle on the eye |
| | sphere is sufficient. 2. The union of all pupil ranges corresponding to all |
| | lenslets of the array. It is a spherical shell to a good approximation. If |
| | all accessible eye pupil positions for an average human are considered, |
| | the boundary of the union of eye pupil ranges is approximately an |
| | ellipse with angular horizontal semi-axis of 60 degrees and vertical |
| | semi-axis of 45 degrees relative to the front direction. 3. The envelope |
| | of the eye positions caused by rotations and tolerance shifts of the |
| | center of the eye ball. |
| virtual screen | Surface containing the ipixels, preferably being a region of the surface |
| | of a sphere concentric with the eye and with radius in the range from 2 |
| | m to infinity. |
| TIR | Total Internal Reflection |
| System with | Optical system that project the light emitted from a display on to the |
| negative | eye in which a (in general, distorted) intermediate real image of the |
| magnification | pupil is formed. Also called “pupil-forming” optics. |
| System with | Optical system that project the light emitted from a display on to the |
| positive | eye in which no intermediate real image of the pupil is formed. Also |
| magnification | called “non-pupil-forming” optics. |

### 3. State of the Art

Head mounted display (HMD) technology is a rapidly developing area. An ideal head mounted display combines a high resolution, a large field of view, a low and well-distributed weight, and a structure with small dimensions.

Prior art relevant to this application include using off-axis mirror based designs as “Rolland” and “Cheng” designs, which do not use a crossed configuration as proposed herein. On the other hand, “Droessler 1” and “Chen 2” describe off-axis systems with a semitransparent mirror in front of the eye, which has optical losses on the contrary to the essentially lossless TIR-based or light-filters based reflection in front of the eye in several of the embodiments disclosed herein.

“Droessler 2” shows a freeform prism that uses TIR reflection, as some embodiments herein (but do not use a crossed configuration), and includes an additional freeform prism to provide the see-though capability to the HMD, as some of the embodiments presented herein.

Finally, “Cheng” discloses a symmetric multichannel TIR freeform prism configuration with multiple displays, with positive magnification, but in a non-crossed configuration; while “Hua” introduces in a TIR freeform prim with positive magnification for a display, a second optical system to capture through the TIR freeform prim an image of the eye pupil for tracking it, having the prism plus camera optics sensor a negative magnification on the sensor. Embodiments herein have either positive or negative magnification in a cross-configuration, and include the possibility to include a camera for eye tracking, although is a very different configuration to “Hua”.

PCT1 discloses multiple concepts that are related to the present application, as opixels, ipixels, clusters, mapping function, gazed region of the virtual screen, among others, while PCT6 discloses a super-resolution technique also related with the present invention, based on (1) the use of variable magnification along the display to show the ipixels of the virtual screen denser where they can be directly gazed, and courser in the rest of the FOV, and (2) the consideration of the eye rotation to maximize the image quality of each ipixel when the eye is gazing at it, so the gazing vector points to the ipixel.

### SUMMARY

The present invention consists in a device for virtual or mixed reality applications that uses an optical system in a crossed configuration, which allow it to obtain an unprecedented compactness for very wide FOV.

A display device is disclosed that includes one or more displays, operable to generate a real image comprising a plurality of object pixels. The device includes an optical system, comprising a plurality of channels arranged to generate an immersive virtual image from the real image. The immersive virtual image comprises a plurality of image pixels, by each channel projecting light from the object pixels to a respective pupil range.

The pupil range comprises an area on the surface of an imaginary sphere of from 21 to 27 mm diameter, and includes a circle subtending 15 degrees whole angle at the center of the sphere.

The object pixels are grouped into clusters, each cluster associated with a channel, so that the channel produces from the object pixels a partial virtual image comprising image pixels, and the partial virtual images combine to form said immersive virtual image.

Imaging light rays falling on the pupil range through a given channel come from pixels of the associated cluster, and the imaging light rays falling on said pupil range from object pixels of a given cluster pass through the associated channel.

The imaging light rays exiting a given channel towards the pupil range and virtually coming from any one image pixel of the immersive virtual image are generated from a single object pixel of the associated cluster.

The clusters of at least two channels are substantially contained in opposite half-spaces defined by a plane passing by the imaginary sphere center.

Each one of the two channels comprises one surface on which the imaging light rays forming the partial virtual image suffer a last reflection before reaching the pupil range.

Each one surface of the two channels is substantially contained in the opposite half-space containing their respective clusters.

In an embodiment, all the object pixels belong to a single display.

In an embodiment, at least one display surface is partially cylindrical in shape.

In an embodiment, at least one display surface is curved.

Optionally, all the object pixels belong to a two flat displays.

In one embodiment, at least one surface is configured to transmit the rays of one of the two channels and reflect the rays of the other channel of the two channels.

The display may include a common optical surface where all the imaging light rays of both two channels are refracted. Optionally, all the imaging light rays of both two channels are also reflected on said common optical surface. In an embodiment, the reflection is total internal. In an embodiment, the reflection is achieved by a light filter. The light filter may be flat. The light filter may be a reflective polarizer, a dichroic filter, angular-selective transparent filter or a semitransparent mirror.

In an embodiment, the last reflecting surfaces of the two channels and their common optical surface may be three faces of a solid dielectric piece of material.

It is contemplate that a portion of each last reflecting surface may also permit transmission of imaging light rays. Optionally, the transmission and reflection of said surface is achieved by a light filter. The light filter is preferably a reflective polarizer, a dichroic filter, angular-selective transparent filter or a semitransparent mirror.

In an embodiment, the last reflecting surface of at least each one of the two channels is a surface of a thin sheet of material.

The last reflecting surfaces of the two channels may be semitransparent to allow for see-through visualization.

Absorbing or reflecting surfaces may be added to eliminate the creation of ghost images.

A refractive corrector element may be added for see-though visualization.

In one embodiment, a reflecting surface of the two channels may comprise a stack of spaced reflectors to reduce the convergence accommodation-mismatch.

It is contemplated that in an embodiment the displays may be directional emitting light within a solid angle which is smaller than the full hemisphere. The directionality may be made using angular-selective transparent filter on top of the display.

Preferably at least one of the displays is a light field display.

It Is contemplated that at least one of the two channels may be an optical system with either (i) a positive magnification, (ii) a negative magnification, or (iii) a positive magnification in one direction and negative magnification in a substantially perpendicular direction.

In an embodiment, the two channels may be substantially contained in opposite half-spaces form the partial virtual images in the central part of the field of view and other channels form partial virtual images of the peripheral part of the field of view.

Any of the embodiments may include a mounting fixture operative to maintain the device in a substantially constant position relative to a normal human head with one eye at the position of the imaginary sphere.

It is contemplated that the optical system may be arranged to produce partial virtual images at least one of which contains a part projected by a human eye onto a 1.5 mm fovea of said eye when said eye is at the eye position with its pupil within a pupil range, said part of said partial virtual image having a higher resolution than when projected on a peripheral part of the retina of said eye when said eye is at a different eye position with its pupil within a pupil range. Preferably, the rays that form the partial virtual images on the fovea are emitted from different cluster than the rays that form the partial virtual images on a peripheral part of the retina of said eye.

It is also contemplated that the pixels of the virtual image may be more dense at the center of the field of view than at the outer region of the field of view.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF DRAWINGS

The above and other aspects, features and advantages of the present invention will be apparent from the following more particular description thereof, presented in conjunction with the following drawings wherein:

FIG. 1A shows an embodiment of the prior art compared to FIG. 1B which shows the present invention.

FIG. 2 illustrates the use of the present invention.

FIG. 3 shows one embodiment of the present invention and a 2D cut through it that is used in other figures

FIG. 4 shows a generic embodiment of the present invention.

FIG. 5 shows one preferred embodiment where the virtual image results from combining the emission of two displays using an optic and light filters.

FIG. 6 shows an embodiment with one single, curved display.

FIG. 7 illustrates the difference in perception on the gazing and peripheral directions.

FIG. 8 shows a combination of optics similar to those in FIG. 5.

FIG. 9 illustrates an optic with negative magnification.

FIG. 10 illustrates an optic with positive magnification.

FIG. 11 illustrates an optic with positive magnification in one direction and negative in the perpendicular direction.

FIG. 12 illustrates a parallel and series combination of different optics.

FIG. 13 shows a CIE diagram with separate emission colors for two different displays.

FIG. 14 shows an optic whose displays emit polarized light and whose light filters are polarizers.

FIG. 15 shows and optic whose displays emit unpolarized light and whose light filters are polarizers.

FIG. 16 shows an optic that uses polarized light, that is substantially symmetric and whose light filters use ¼ wavelength retarders and polarizers.

FIG. 17 shows an optic that uses polarized light, that is substantially symmetric and whose ¼ wavelength retarder is physically separated from the polarizers used as light filters.

FIG. 18 shows the structure of an absorbing polarizer to prevent ghost images.

FIG. 19 shows an optic similar to that in FIG. 5 but with additional optical components for improved image quality.

FIG. 20 shows an optic whose channels from the two separate displays are split by a bottom lens with a discontinuity in derivative.

FIG. 21 shows an optic similar to that in FIG. 20 but in which the bottom lens and the main optic are one single element.

FIG. 22 shows an asymmetric optic composed of a central main optic and a side optic for increased field of view.

FIG. 23 shows an optic with additional mirrors and polarizers at its bottom surface to ensure reflection when TIR fails and to prevent ghost images.

FIG. 24 shows an optic composed of a central optic and two projectors matched with two displays.

FIG. 25 shows a configuration with projectors and a corrector element for a see-through configuration.

FIG. 26 shows a configuration with angled projectors for improved compactness.

FIG. 27 shows a configuration in which the angled projectors form a single element with the central optic.

FIG. 28 shows a configuration with folded projectors for improved compactness.

FIG. 29 shows a configuration in which the projectors are folded optics and form a single element with the central optic.

FIG. 30 shows a configuration with compact projectors based on polarized light.

FIG. 31 shows the illumination system of the projectors in FIG. 30 when the display is an LCoS.

FIG. 32 shows a configuration in air using projectors and light filters.

FIG. 33 shows a configuration in air using mirrors or light filters for see-through configurations.

FIG. 34 shows a configuration in air that allows dimmable see-through.

FIG. 35 shows a possible wearing of the current invention.

FIG. 36 shows configuration similar to that in FIG. 33 but in which the projectors are rotated in 3D space.

FIG. 37 shows configuration similar to that in FIG. 33 but in which the projectors are rotated in 3D space.

FIG. 38 shows a configuration in air based on mirrors (or light filters for see-through) with folded projectors.

FIG. 39 shows a solid configuration with folded projectors.

FIG. 40 shows a configuration in air with virtual images created at two distances for reducing the convergence-accommodation mismatch.

FIG. 41 shows a four-fold embodiment.

FIG. 42 shows a stack of liquid crystals and polarizers that may be used as a commutable mirror.

FIG. 43 shows a configuration in air for displaying virtual images at commutable distances.

FIG. 44 shows a solid configuration for displaying virtual images at commutable distances.

FIG. 45 shows a solid configuration whose projectors have commutable configurations.

FIG. 46 shows a preferred embodiment of the present invention showing local coordinate systems for the mathematical description of its surfaces.

FIG. 47 shows light rays of the configuration in FIG. 46 for different gazing directions.

FIG. 48 shows light rays of the configuration in FIG. 46 gazing and peripheral vision.

FIG. 49 shows the light rays defining the pupil range of the embodiment in FIG. 46.

FIG. 50 shows a perspective view of the embodiment shown in FIG. 46.

FIG. 51 shows a perspective view of the embodiment shown in FIG. 46.

FIG. 52 shows the geometry used in the calculation of a retarder's thickness and rotation.

FIG. 53 shows an embodiment that separates the rays that reach the fovea from the rays that reach the retina outside the fovea.

FIG. 54 shows a configuration designed for a curved display.

FIG. 55 shows the same configuration as in FIG. 54, but now in a three-dimensional view.

FIG. 56 shows an embodiment with a central main optic and side projectors.

FIG. 57 shows a three-dimensional view of the optic in FIG. 56.

FIG. 58 shows an embodiment with semitransparent mirrors on some surfaces of its central main optic.

FIG. 59 shows an embodiment with a correcting element that allows for a see-through configuration.

### DETAILED DESCRIPTION

A better understanding of the features and advantages of the present invention will be obtained by reference to the following detailed description of the invention and accompanying drawings, which set forth illustrative embodiments in which the principles of the invention are utilized.

The embodiments in the present invention include an optical device (per eye) that transmits the light from one or several digital displays to the area of the pupil range of the eye through use of an optical system comprising a plurality of channels arranged to generate an immersive virtual image from the real image. The immersive virtual image comprises a plurality of image pixels, by each channel projecting light from the object pixels to a respective pupil range. The pupil range comprises an area on the surface of an imaginary sphere of from 21 to 27 mm diameter, and includes a circle subtending 15 degrees whole angle at the center of the sphere.

The object pixels are grouped into clusters, each cluster associated with a channel, so that the channel produces from the object pixels a partial virtual image comprising image pixels, and the partial virtual images combine to form said immersive virtual image.

Imaging light rays falling on the pupil range through a given channel come from pixels of the associated cluster, and the imaging light rays falling on said pupil range from object pixels of a given cluster pass through the associated channel.

The imaging light rays exiting a given channel towards the pupil range and virtually coming from any one image pixel of the immersive virtual image are generated from a single object pixel of the associated cluster.

The clusters of at least two channels are substantially contained in opposite half-spaces defined by a plane passing by the imaginary sphere center.

Each one of the two channels comprises one surface on which the imaging light rays forming the partial virtual image suffer a last reflection before reaching the pupil range.

Each one surface of the two channels is substantially contained in the opposite half-space containing their respective clusters.

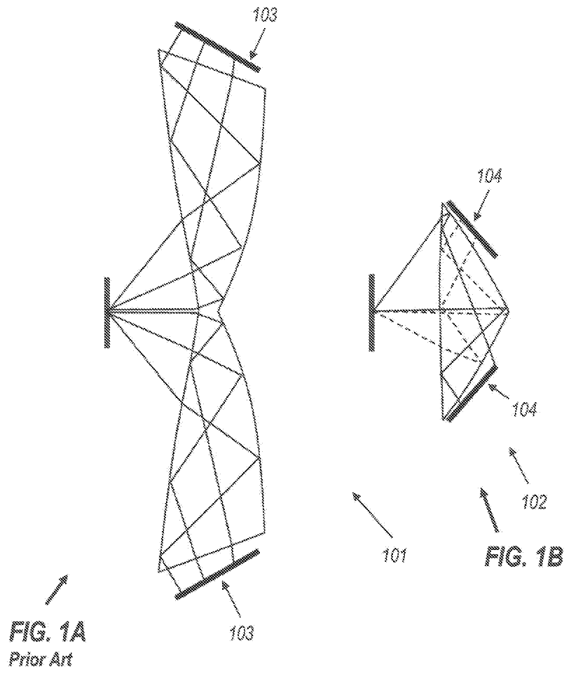

Referring now to the drawings, FIG. 1A shows an embodiment 101 of the prior art (U.S. Pat. No. 9,244,277 B2, the disclosure of which is incorporated herein by reference in its entirety) compared to an embodiment 102 (FIG. 1B) of similar function of present invention. In both cases the field of view is split into two channels with corresponding displays 103 or 104. The present invention is significantly more compact.

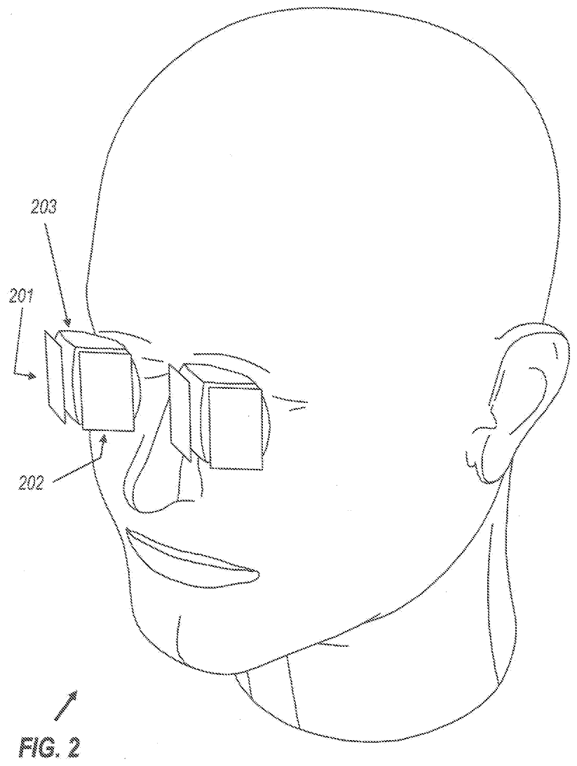

FIG. 2 shows a preferred embodiment of the present invention comprising displays 201 and 202 and optic 203. This assembly is placed in front of an eye providing a wide view vision of a scene. Another similar set is placed in front of the other eye. The combined images of the two devices produce a tree-dimensional effect. In another embodiment, said assembly may be rotated 90 deg so that displays 201 and 202 instead of being in the horizontal direction are in the vertical direction.

Said displays used in the current invention may be Light Field Displays, which will allow to reduce the vergence accommodation mismatch and provide directionality of the light emitted from the display to eliminate rays causing ghost images or straylight.

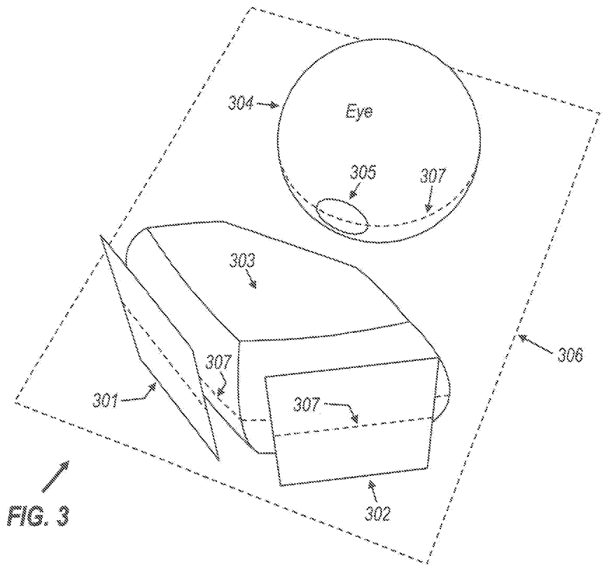

FIG. 3 shows similar elements to those in FIG. 2, but now isolated. The light emitted by displays 301 and 302 travels inside optic 303 entering the eye 304 through its pupil 305 and forming an image on the retina, at the back of the eye. Also shown is plane 306 that cuts the optic and eye in two through the dashed lines 307.

Optic 303 may be cut with the cone defining the field of view (similarly to what is shown in FIG. 2). Optic 303 may further be cut with a plane to leave extra room for the nose.

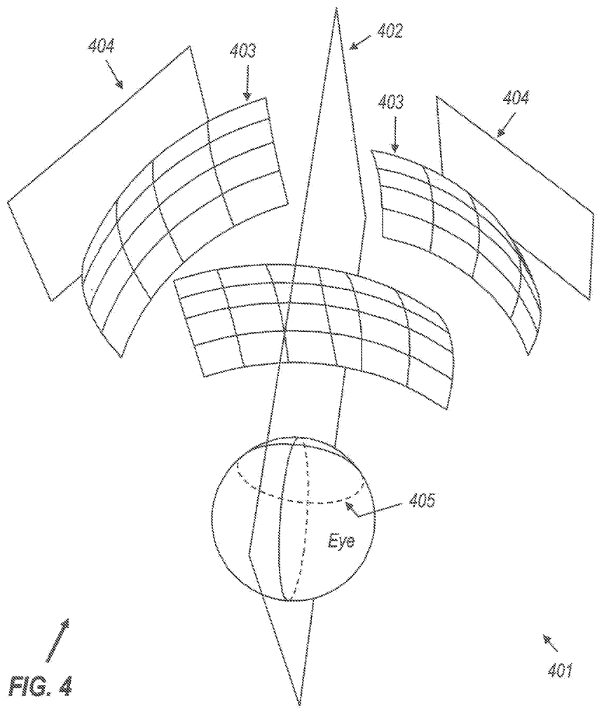

FIG. 4 shows generic embodiment 401. Space is split into two half-spaces by plane 402 through the center of the eye ball center. Said embodiment comprises at least two channels substantially contained in opposite said half-spaces. Each of these channels captures the light from one display 404 and comprise a last surface 403 that reflects the light towards the eye. Said channels comprise one surface on which the imaging light rays forming a partial virtual image suffer the last reflection before reaching the pupil range 405.

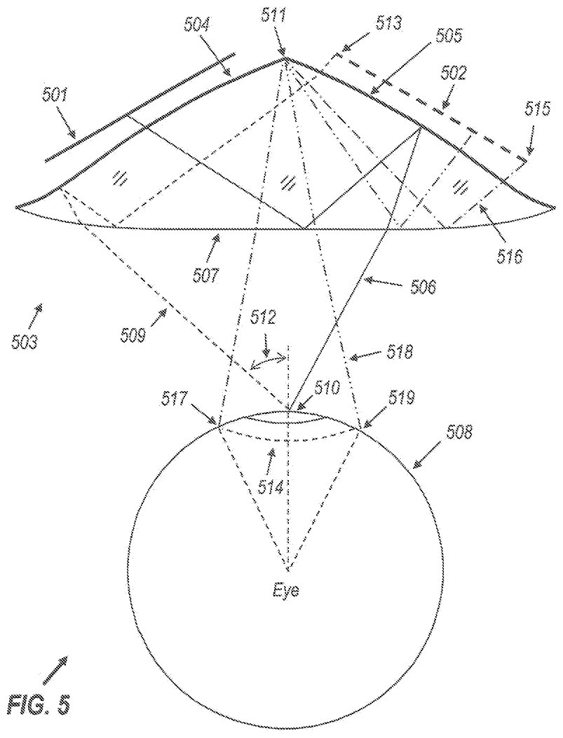

FIG. 5 shows the cut 307 through the assembly shown in FIG. 3. Surface 504 of optic 503 is a light filter substantially transmissive to the light emitted by display 501 and substantially reflective to the light emitted by display 502. Surface 505 of optic 503 is a light filter substantially transmissive to the light emitted by display 502 and substantially reflective to the light emitted by display 501. Optic 503 is made of a transparent material.

A light ray 506 emitted from display 501 will refract at surface 504 as it enters optic 503. It then undergoes Total Internal Reflection (TIR) at surface 507 of optic 503, being redirected towards surface 505 where it is reflected. It is then refracted at surface 507 of optic 503 towards the eye 508. The eye pupil 510 points at optic 503.

Accordingly, a light ray 509 emitted from display 502 will refract at surface 505 as it enters optic 503. It then undergoes Total Internal Reflection (TIR) at surface 507 of optic 503, being redirected towards surface 504 where it is reflected. It is then refracted at surface 507 of optic 503 towards the eye 508.

This configuration allows both displays 501 and 502 to share a common optic 503 reducing the overall size of the device when compared to the prior art.

Different methods may be used to make optical surface 504 substantially transparent to the light emitted by display 501 and substantially reflective to the light emitted by display 502. Those same methods may be applied to optical surface 505 which is substantially transparent to the light emitted by display 502 and substantially reflective to the light emitted by display 501.

Displays 501 and 502 may be directional (emitting most light in a preferred direction cone) to improve efficiency and reduce stray light.

Ray 509 that is emitted from the edge 513 of display 502 and reaches the center of the pupil 510 defines the field of view in this cross section, which is double the angle 512 in this symmetric configuration (an asymmetric version of this device easily follows from this one). On the other hand, ray 516 that is emitted from the other edge 515 of display 502 and is reflected by light filter 504 at its edge point 511 defines the edge 517 of the pupil range 514 when intersecting the eye ball surface. Finally, all rays that illuminate the pupil range 514 within the FOV should fulfill the TIR condition, particularly ray 518 that is the one reaching the eye ball surface at edge 519 of the pupil range after having been reflected by light filter 504 at its edge 511.

In another embodiment, light filters 504 and 505 may be angular-selective transparent filters that transmit some rays while reflecting others (see, https://luxlabs.co/optical-angular-selective-material/ which is incorporated herein by reference in its entirety).

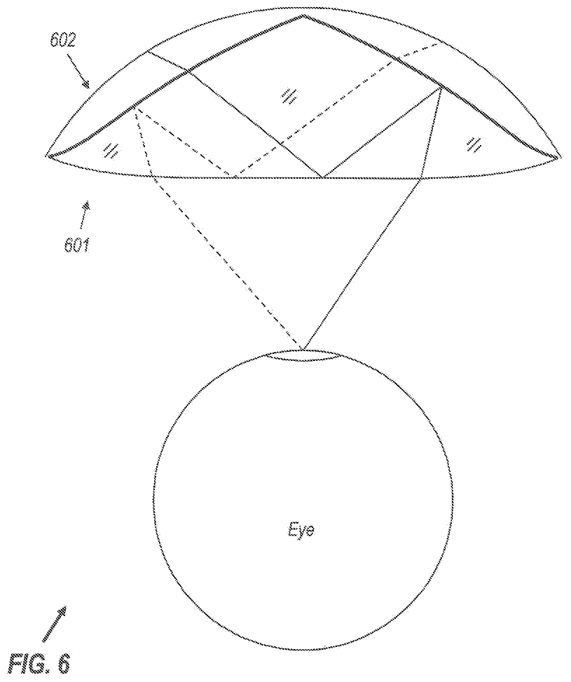

FIG. 6 shows an embodiment 601 similar to embodiment 503 disclosed in FIG. 5, but designed for a single curved display 602.

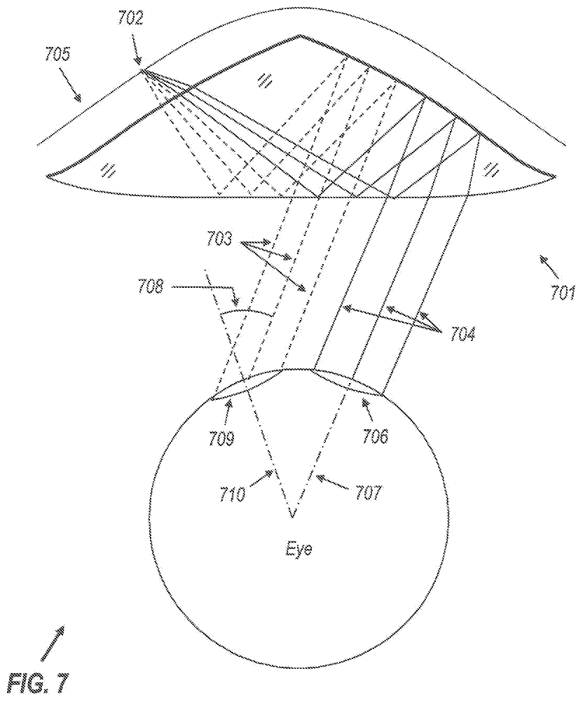

FIG. 7 shows embodiment 701 similar to that shown in FIG. 6. Rays emitted from point 702 on display 705 will leave the optic as a bundle of rays comprising rays 703 and 704 forming a virtual image of point 702.

Rays 704 are seen straight on when the eye pupil 706 gazes in direction 707 and these rays form an image on the fovea. It is therefore very important that the image quality is high for rays 704 since the fovea can resolve high quality images.

Rays 703 are seen at a wide angle 708 when the eye pupil 709 is gazing in direction 710. This peripheral vision of the virtual image of point 702 is poor since the eye cannot resolve well objects at wide angles. For that reason, the image quality of the virtual image formed by rays 703 does not need to be as high as that formed by rays 704. Moreover, since the eye is typically (90% of the time) gazing within a cone of 40 degrees full angle with axis on the frontwards direction, and usually the rim to the optics limits physically the gazed region of the virtual screen to a cone of 60 deg full angle, the ipixel to opixel mapping is done preferably non-uniformly (i.e, with nonvariable magnification) so the ipixels are more dense in the 40 deg full angle cone and its density decrease gradually towards the outer region of the virtual screen up to the edge of the FOV.

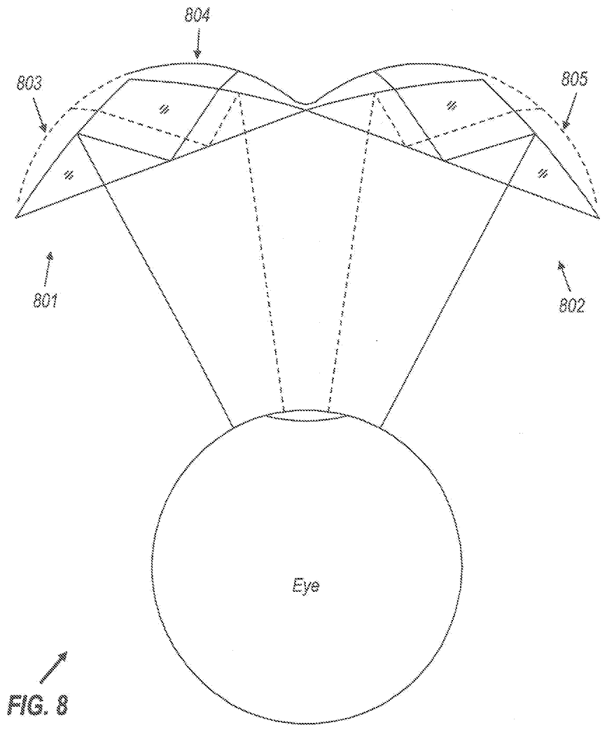

FIG. 8 shows an embodiment comprising two optics 801 and 802 similar to optic 503 in FIG. 5. This new embodiment uses a single display for all optics 801 and 802. The display emits light with different characteristics in its sections 803, 804 and 805 so that the emitted light is either transmitted or reflected in the different light filters, according to what is disclosed in FIG. 5. In another embodiment the different sections 803, 804 and 805 may be separate components.

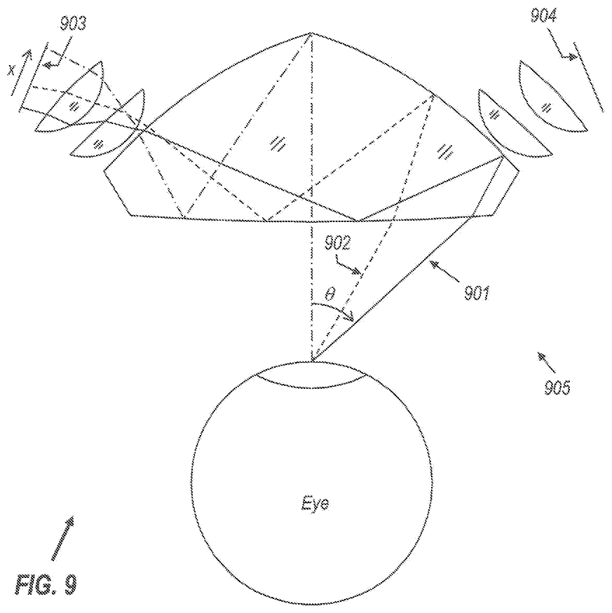

FIG. 9 shows an embodiment whose rays 901 and 902 emitted from display 903 cross inside the optic 905 forming a caustic there. Light rays emitted from display 904 have a symmetric behavior relative their interactions with the optical surfaces of optic 905. This optic has a negative magnification because as angle θ at the image increases, the corresponding coordinate x at display 903 decreases.

In another embodiment the optic may have positive magnification in one direction and negative magnification in a substantially perpendicular direction.

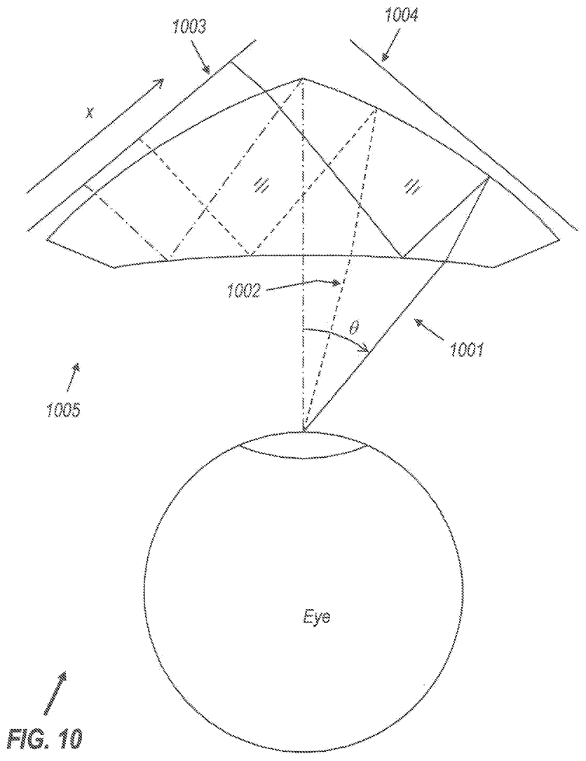

FIG. 10 shows an embodiment whose rays 1001 and 1002 emitted from display 1003 do not cross inside optic 1005 and therefore their caustic is outside the optic. Light rays emitted from display 1004 have a symmetrical behavior relative to their interactions with the optical surfaces of optic 1005. This optic has a positive magnification because as angle θ at the image increases, the corresponding coordinate x at display 1003 increases.

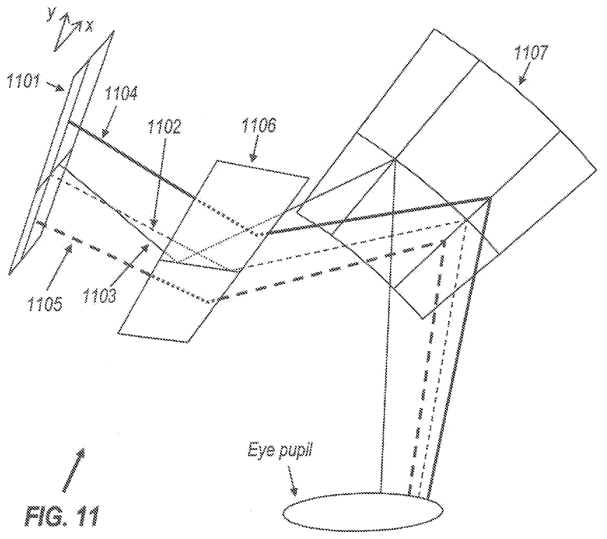

FIG. 11 shows a configuration in which rays emitted from a display 1101 are reflected by mirrors 1106 and 1107 towards the eye pupil. Exemplary rays 1102 and 1103 emitted from display 1101 along direction x cross inside the device before reaching the eye pupil. Exemplary rays 1105, 1102 and 1104 emitted from display 1101 along direction y do not cross inside the device before reaching the eye pupil. This device then has magnifications of opposite signs (negative and positive) in directions x and y. In general, one optic may have positive or negative magnification in the x direction and positive or negative magnification in the y direction, leading to four possibilities to map display and virtual image in the image forming process.

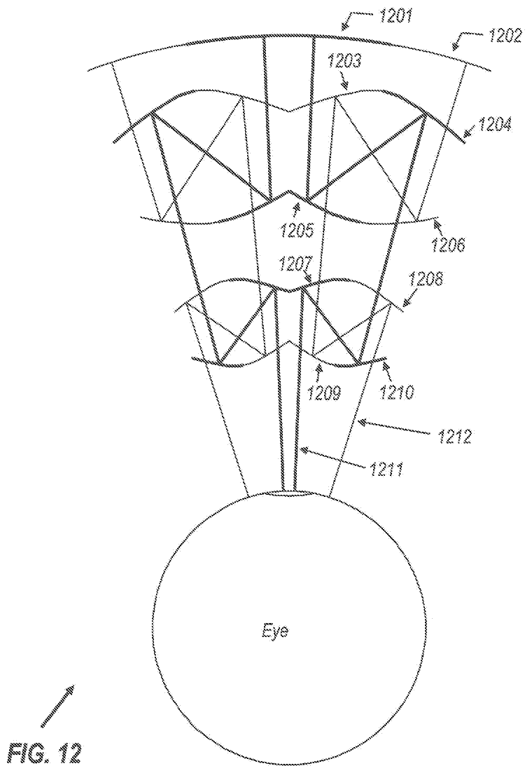

FIG. 12 shows an example of a series and parallel combination of optics. In this embodiment, light filters 1205, 1204, 1210 and 1207 are substantially reflective to the light emitted by display 1201 and substantially transmissive to the light emitted by display 1202. Also, light filters 1206, 1203, 1209 and 1208 are substantially reflective to the light emitted by display 1202 and substantially transmissive to the light emitted by display 1201. The paths of light inside the embodiment is illustrated by exemplary ray 1211 emitted from display 1201 and exemplary ray 1212 emitted from display 1202. The whole embodiment in this exemplary configuration has left-right symmetry. Displays 1201, 1202 and their symmetrical may be one single element with varying emitting characteristics across its extent.

In this embodiment, a light ray emitted from display 1202 could cross light filters 1204, 1205 and 1207 directly, but would be reflected by light filter 1209 preventing it from reaching the eye directly.

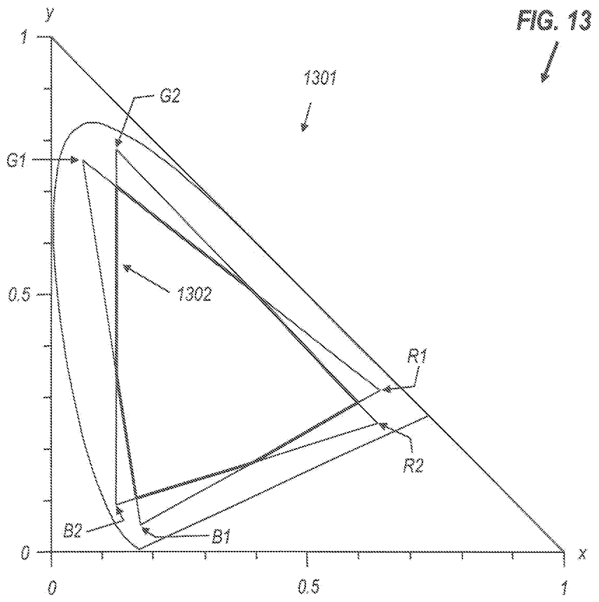

FIG. 13 shows a CIE 1931 color space 1301. Referring back to the embodiment in FIG. 5, display 501 forms an image by emitting red, green and blue (RGB) light whose color coordinates are given by R1, G1, B1. Also, display 502 forms an image by emitting RGB light whose color coordinates are given by R2, G2, B2. The color gamut possible for both displays is the intersection 1302 of triangles R1, G1, B1 and R2, G2, B2.

In a possible embodiment, light filter 504 of optic 503 is a dichroic mirror substantially transmissive to the light emitted by display 501 and therefore to light of colors R1, G1, B1 and substantially reflective to the light emitted by display 502 and therefore of colors R2, G2, B2. Also, light filter 505 of optic 503 is a dichroic mirror substantially transmissive to the light emitted by display 502 and therefore to light of colors R2, G2, B2 and substantially reflective to the light emitted by display 501 and therefore to light of colors R1, G1, B1.

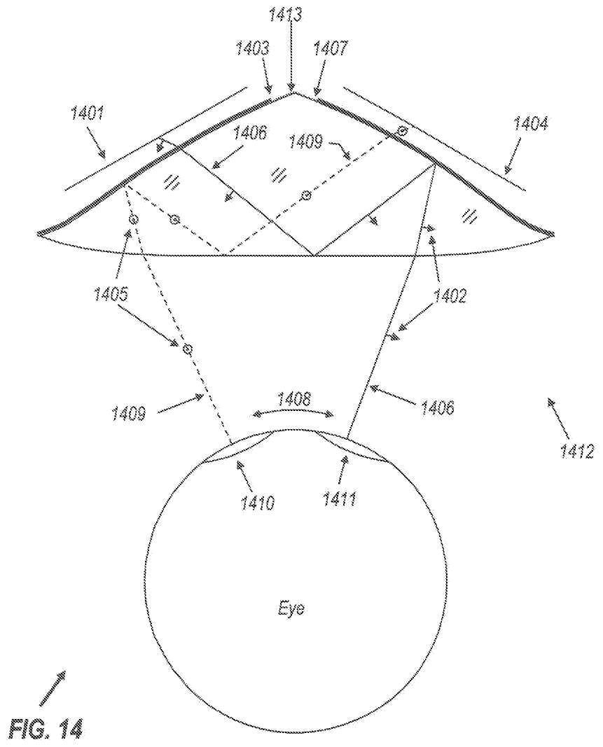

FIG. 14 shows an embodiment comprising displays 1401 and 1404 that emit polarized light. Display 1401 may be a Liquid-Crystal Display (LCD) that emits light linearly polarized on the plane of the figure, as indicated by arrows 1402. Display 1404 may also be an LCD, but that emits light linearly polarized in the direction perpendicular to the plane of the figure, as indicated by circles and centered dots (arrow tips pointing towards the reader) 1405. In this embodiment, optical surface 1403 is a light filter substantially transparent to the polarized light emitted by display 1401 and substantially reflective to the polarized light emitted by display 1404. Optical surface 1407 is a light filter substantially transparent to the polarized light emitted by display 1404 and substantially reflective to the polarized light emitted by display 1401. Surfaces 1403 and 1407 are reflective polarizers, for example wire grid polarizers or birefringence multilayer polarizers. Both can be made by laminating or insert-injection molding of a reflective polarizing film on the plastic surface, for instance with Asahi Kasei WGF product for the latter, and 3M APDF or DBEF products. This lamination or insert-molding is rather easy if the surfaces 1403 and 1407 are flat or cylindrical, because materials of the films are not stressed in the process, but can also be performed if the surfaces are doubly-curved by doing it with minimum deformation in a thermal conformation with application of pressure or vacuum, or for instance as described in U.S. Pat. No. 9,581,527 B1 by Wang et al. (the disclosure of which is incorporated herein by reference in its entirety. To obtain the minimum inactive area at the joint of surfaces 1403 and 1407, the reflective polarizer films may be not reach the corner and a metallic mirror 1413 can be deposited there instead.

In the embodiment shown in FIG. 14, the path of ray 1406 is then similar, in its interactions with the optic, to that of ray 506 in FIG. 5. Also, the path of ray 1409 is similar, in its interactions with the optic, to that of ray 509 in FIG. 5.

As the eye moves in different directions 1410 or 1411, as indicated by rotation 1408 of the eye pupil within the pupil range, it will gaze at either the light ray 1409 or the light ray 1406.

In general, the two polarizations of the light travelling inside the optic have an arbitrary orientation, as long as they are perpendicular to each other so that they can be distinguished by reflective polarizers 1403 and 1407.

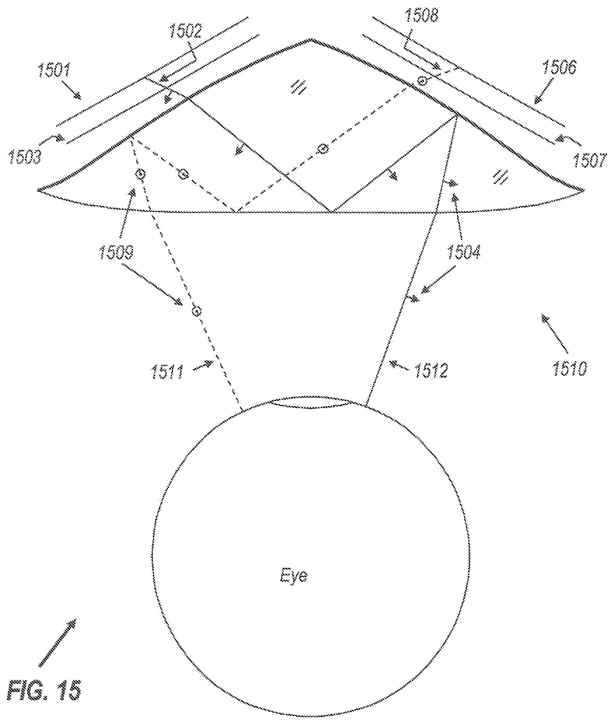

FIG. 15 shows and embodiment comprising display 1501 that emits unpolarized light 1502. Its light encounters an absorbing polarizer 1503 that lets through only a linear polarization on the plane of the figure, as indicated by arrows 1504, and absorbs light with other polarizations. Display 1506 emits unpolarized light 1508. Its light encounters an absorbing polarizer 1507 that lets through only a linear polarization in the direction perpendicular to the plane of the figure, as indicated by circles and centered dots (arrow tips pointing towards the reader) 1509, and absorbs light with other polarizations.

Optic 1510 is similar to optic 1412 in FIG. 14. The characteristics and direction of light crossing said optics are also similar in FIG. 14 and FIG. 15 and the paths of rays 1511 and 1512 are similar to those of rays 1409 and 1406.

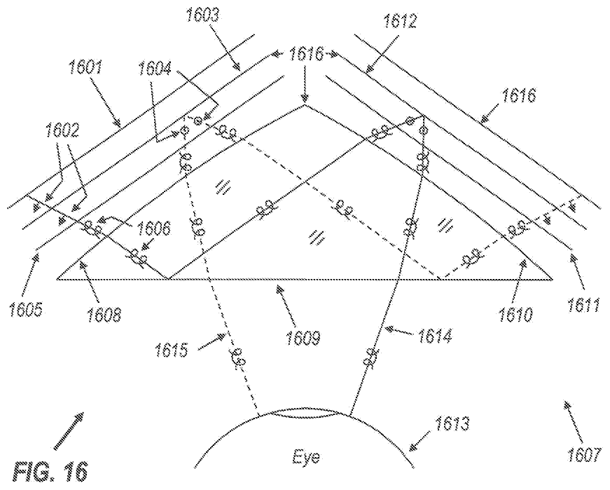

FIG. 16 shows an embodiment including a display 1601 that emits linearly polarized light on the plane of the figure, as indicated by arrows 1602. Following the path of ray 1614, this light crosses polarizer 1603 that transmits this polarization, but reflects its perpendicular, as indicated by circles and centered dots 1604. Light then crosses ¼ wavelength retarder 1605 that transforms the linear polarization to circular polarization (as indicated by spirals 1606). Light is then refracted into optic 1607 at its top surface 1608. It then suffers TIR at the bottom surface 1609 of the optic, then it is again refracted at the top surface 1610 of the optic reaching ¼ wavelength retarder 1611 that transforms the polarization of the light to linear, but in the direction perpendicular to the plane of the figure. This light is then reflected by polarizer 1612 (which is similar to 1603) and again crosses the ¼ wavelength retarder 1611 turning again the polarization to circular. The light ray is then refracted at top surface 1610 and then at the bottom surface 1609, leaving optic 1607 towards the eye 1613.

The path of ray 1615 starts at display 1616 and has a similar but symmetric sequence of events as it crosses the optical system.

Similarly to the embodiment in FIG. 15, display 1601 may be replaced by a display that emits unpolarized light combined with an absorbing polarizer that lets through only polarized light.

Distances between points 1616 (the tip of optic 1607 and the ends of polarizers 1603 and 1612) should be as small as possible to avoid artifacts in the virtual image when the eye gazes frontward (vertical direction in the figure).

While the top surfaces 1608 and 1610 of optic 1607 are preferably curved, polarizers 1603 and 1612 and wave retarders 1605 and 1611 are preferably flat.

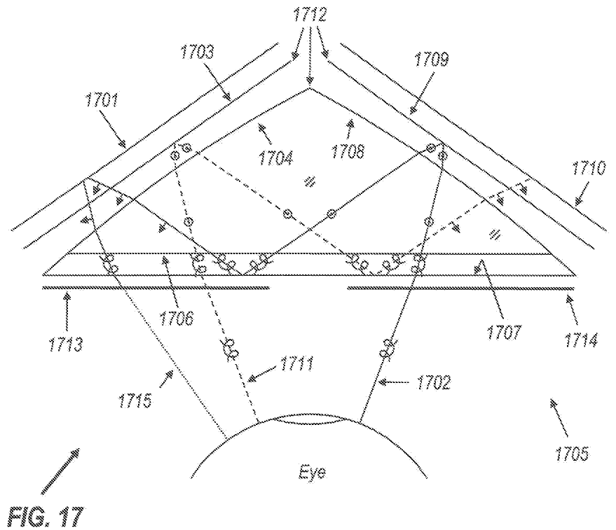

FIG. 17 shows an embodiment including display 1701 that emits linearly polarized light on the plane of the figure. Following the path of ray 1702, emitted from display 1701, it first encounters reflective polarizer 1703 that is transmissive to polarized light on the plane of the figure. It then proceeds to the top surface 1704 of optic 1705 where it is refracted. It then crosses ¼ wavelength retarder 1706 where its polarization changes to circular. After TIR on the bottom surface 1707 of optic 1705, the light ray again crosses ¼ wavelength retarder 1706 where its polarization again changes to linear, but now in the direction perpendicular to the plane of the figure. It is then refracted at top surface 1708 of optic 1705 and reaches reflective polarizer 1709 similar to 1703. There, the light ray is reflected back to the top surface 1708 of optic 1705 where it is again refracted towards the ¼ wavelength retarder 1706 where its polarization again changes to circular. Finally, the ray is refracted out of the optic at surface 1707 and into the eye.

Display 1710 is similar to display 1701 and emits ray 1711 whose interactions with the optical system are symmetrical to those of ray 1702.

Distances between points 1712 (the tip of optic 1705 and the ends of polarizers 1703 and 1709) should be as small as possible to avoid artifacts in the virtual image when the eye gazes frontward (vertical direction in the figure).

While the top surfaces 1704 and 1708 of optic 1705 are preferably curved, polarizers 1703 and 1709 are preferably flat.

Additional light filters 1713 and 1714 may be added to avoid light leakage from the displays directly towards the eye, as exemplified by light ray 1715 that is emitted by display 1701 and refracts in and out of optic 1705, but is stopped by light filter 1713 preventing it from reaching the eye and creating a ghost image.

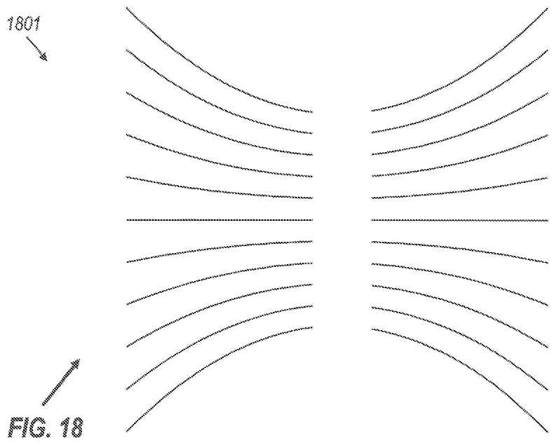

FIG. 18 shows the structure 1801 of an absorbing polarizer to suppress ghost images.

In the embodiment with positive magnification of FIG. 17 that uses retarder plates, the light coming from displays 1701 and 1710 that does not suffer TIR (such as exemplary ray 1715) is suppressed by polarizers 1713 and 1714 after crossing retarder 1706.

In order to avoid the appearance of ghost images due to the Maltese cross effect (which consists in the fact that two crossed polarizers do not cancel the transmission for skew incidence), one of the polarizers or both can be manufactured with non parallel passing directions. If polarizers 1713 and 1714 are tailored as in structure 1801 the Maltese cross will not appear.

This concept can be applied to other embodiments in the patent.

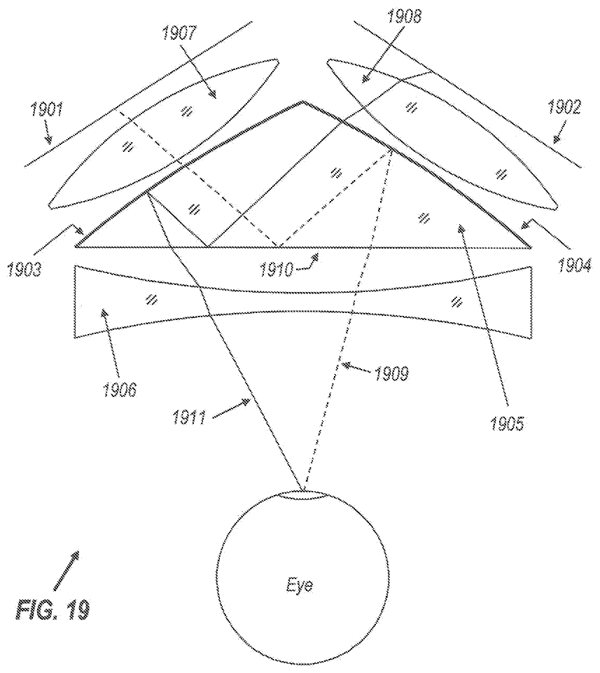

FIG. 19 shows an embodiment comprising two displays 1901 and 1902, light filters 1903 and 1904, central optic 1905 and optional lenses 1906, 1907 and 1908. Here, light filter 1903 is substantially transmissive to the light emitted by display 1901 and substantially reflective to the light emitted by display 1902. Also, light filter 1904 is substantially transmissive to the light emitted by display 1902 and substantially reflective to the light emitted by display 1901.

As illustrated by exemplary ray 1909, light emitted by display 1901 crosses lens 1907 and light filter 1903 refracting into central optic 1905. At its bottom surface 1910 the ray suffers TIR, being reflected back at light filter 1904 to refract out of optic 1905 through its bottom surface 1910, crossing optic 1906 and heading towards the eye. Exemplary ray 1911 emitted from display 1902 as a symmetrical behavior in its interactions with the different optical elements in the embodiment.

Some or all of lenses 1907, 1908 and 1906 may or may not be present in this embodiment. Also, these lenses may be of a different refractive index as that of central optic 1905. Some may be cemented to the central optic forming a single block by eliminating air gaps between lenses 1906, 1907 or 1908 and the central optic 1905. These configurations may be used, for example, for chromatic correction.

Although single lenses 1906, 1907 and 1908 are shown, in general each one of these may be a train of several lenses.

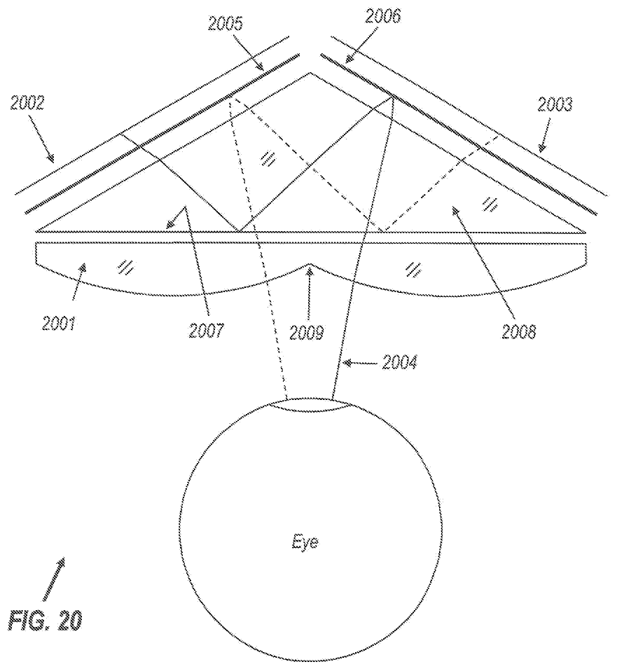

FIG. 20 shows and embodiment similar to that shown in FIG. 19 but with a modified version 2001 of the bottom lens 1906. For simplicity, top lenses 1907 and 1908 are not shown, but they may or may not be present in the embodiment. Light ray 2004 emitted from display 2002 crosses light filter 2005 entering central optic 2008 where it suffers TIR substantially at the left half of bottom surface 2007 of central optic 2008. After being reflected at light filter 2006, it again enters central optic 2008 leaving it after refraction substantially at the right half of bottom surface 2007 of central optic 2008.

The discontinuity in derivative at 2009 of the bottom surface of lens 2001 joins the light coming for displays 2002 and 2003 through different channels inside optic 2008.

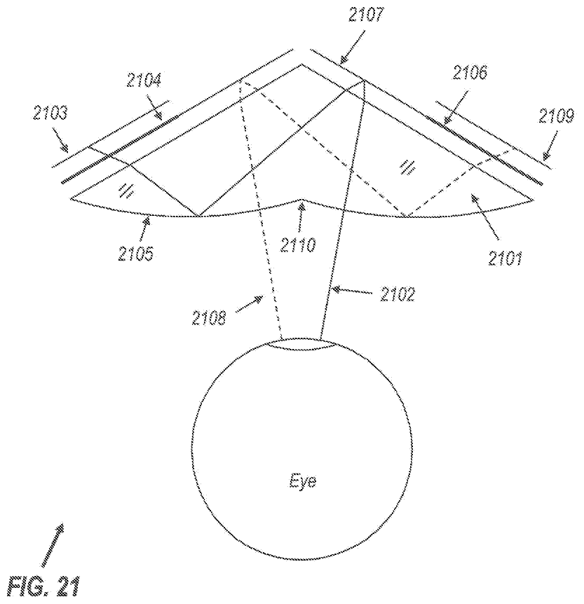

FIG. 21 shows and embodiment similar to that in FIG. 20 but in which components 2001 and 2008 have been combined into a single element 2101. Light ray 2102 emitted from display 2103 crosses light filter 2104 refracting into optic 2101 where it suffers TIR at its left bottom surface 2105 being then refracted out of optic 2101 to be reflected at either light filter 2106 or mirror 2107, again refracted into optic 2101 to be again refracted out of optic 2101, reaching the eye. Light ray 2108 emitted from display 2109 as a symmetrical behavior to that of ray 2102.

In this embodiment, light filter 2104 is substantially transmissive to the light emitted by display 2103 and substantially reflective to the light emitted by display 2109. Also, light filter 2106 is substantially transmissive to the light emitted by display 2109 and substantially reflective to the light emitted by display 2103.

The bottom surface of optic 2101 has a discontinuity in derivative at point 2110 that separated the left and right channels of light travelling inside the optic.

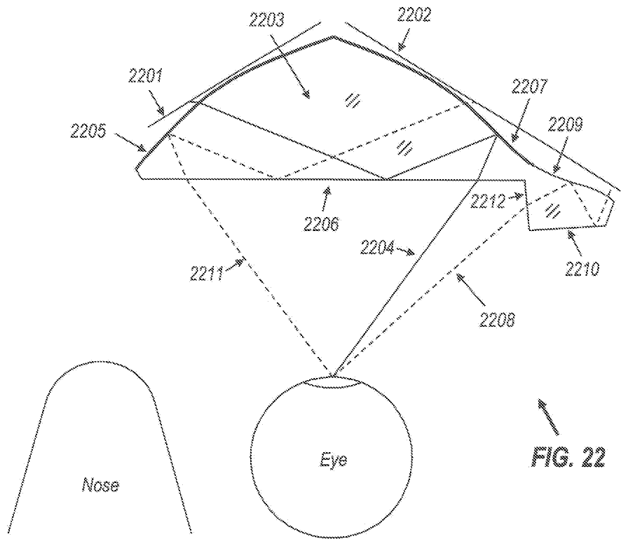

FIG. 22 shows an asymmetric embodiment comprised of displays 2201 and 2202 and optic 2203. A light ray 2204 emitted by display 2201 refracts into optic 2203 through light filter 2205 that is substantially transmissive to the light emitted by display 2201 and substantially reflective to the light emitted by display 2202. This light ray then undergoes TIR at the bottom surface 2206, and is reflected at light filter 2207 that is substantially reflective to the light emitted by display 2201 and substantially transmissive to the light emitted by display 2202. The light ray is then refracted out of optic 2203 though its bottom surface 2206, heading towards the eye.

Another light ray 2208 emitted by display 2202 refracts into optic 2203 through its top surface 2209. It is then reflected at mirrored surface 2210, undergoes TIR at top surface 2209 and refracts out of optic 2203 at surface 2212, heading towards the eye.

Light ray 2211 has symmetrical behavior relative to ray 2204.

The component defined by surfaces 2209, 2210, 2212 may be of a different nature, for example a lens or a set of lenses.

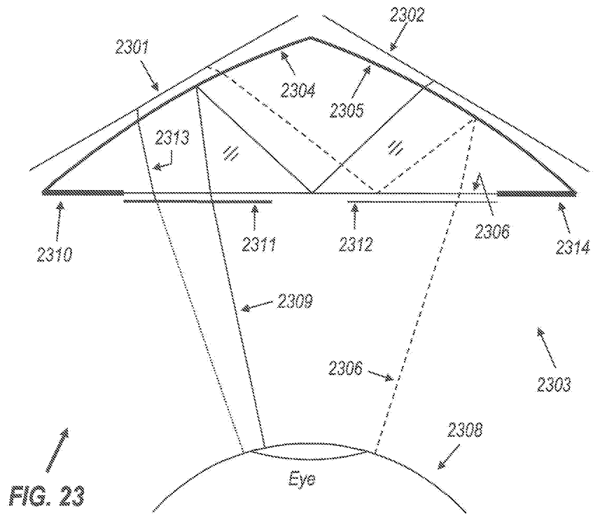

FIG. 23 shows an embodiment 2303 similar to embodiment 503 in FIG. 5. It includes displays 2301 and 2302, light filters 2304 and 2305, similarly to components 501, 502, 504 and 505 in FIG. 5. This new embodiment includes light filter 2311 that is substantially transmissive to the light emitted by display 2302 (as indicated by ray 2309 crossing it) and substantially absorptive to light emitted by display 2301. Light ray 2313 emitted from display 2301 is then absorbed by light filter 2311, preventing it from reaching the eye 2308 directly and creating there an undesirable secondary (ghost) image. Accordingly, light filter 2312 is substantially transmissive to the light emitted by display 2301 (as indicated by ray 2306 crossing it) and substantially absorptive to light emitted by display 2302.

Element 2310 may be a light filter that is substantially reflective to the light emitted by display 2301 and substantially transmissive to the light emitted by display 2302. This will allow the reflection of light emitted from display 2301 if TIR fails at these extreme positions in the optic. Accordingly, element 2314 may be a light filter that is substantially reflective to the light emitted by display 2302 and substantially transmissive to the light emitted by display 2301.

In an alternative configuration, elements 2310 and 2314 are mirrors, again guaranteeing that light is still reflected inside optic 2303 even if TIR fails at the edges. In this case the aperture 2306 of optic 2303 is reduced by mirrors 2310 and 2314.

In a given configuration, all or some of the elements 2310, 2311, 2312 and 2314 may or may not be present.

In another embodiment, displays 2301 and 2302 may be made directional avoiding the emission of light such as ray 2313 and therefore the need to incorporate light filters 2311 and 2312. This may be achieved using covering said displays with films as those described in U.S. Pat. No. 7,467,873 B2, the disclosure of which is incorporated herein by reference.

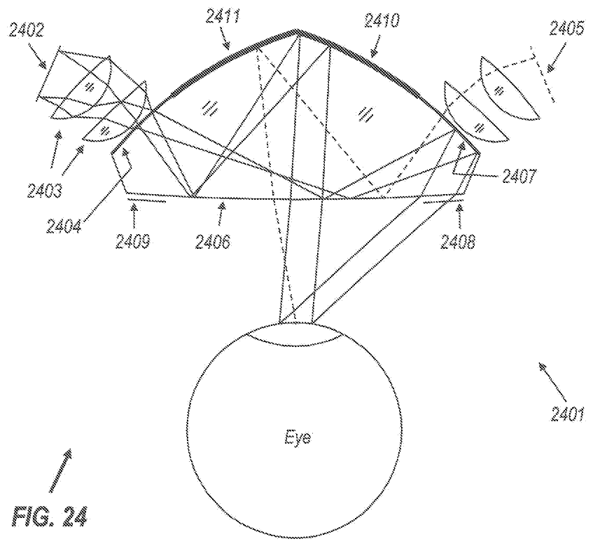

FIG. 24 shows an embodiment 2401 with a negative magnification. Light emitted from display 2402 first crosses different optical elements 2403 constituting a projector. This light then crosses light filter 2404 that is substantially transmissive to the light emitted by display 2402 and substantially reflective to the light emitted by display 2405. Light then continues its path by TIR (Total Internal Reflection) at the bottom surface 2406 of embodiment 2401, and it is then reflected at mirror 2410 or light filter 2407 that is substantially transmissive to the light emitted by display 2405 and substantially reflective to the light emitted by display 2402. Finally, light is refracted at surface 2406 in its way to the eye.

This configuration may also include light filter 2408 that is substantially transmissive to the light emitted by display 2402 and substantially absorptive to the light emitted by display 2405. This prevents light from display 2405 that does not have TIR at bottom surface 2406 to reach the eye directly creating a ghost image. Accordingly, optional light filter 2409 is substantially transmissive to the light emitted by display 2405 and substantially absorptive to the light emitted by display 2402.

In one configuration, elements 2410 and 2411 are mirrored surfaces. In another configuration, elements 2404 and 2411 are a single light filter with the characteristics described above for 2404. Also, elements 2407 and 2410 are a single light filter with the characteristics described above for 2407.

In another configuration, optical elements 2403 are lenses that would include the means for the chromatic aberration correction of the system at least for the green subpixel spectrum color (and correct the centroid position of the blue and red subpixel by software), and such a correction can be done with standard techniques as combining positive and negative elements, with the same or different dispersion coefficients, forming cemented doublets or using air spaces, and including or not diffractive kinoforms.

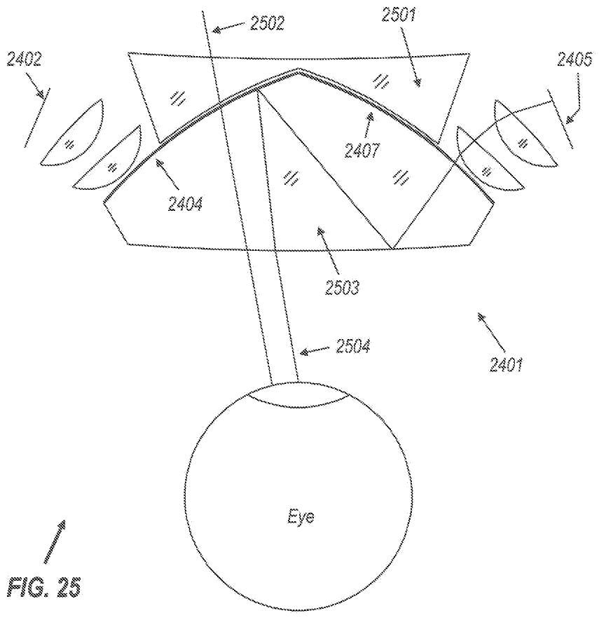

FIG. 25 shows the same embodiment 2401 as FIG. 24, but with a corrector element 2501 added. In this new configuration, light filter 2404 is substantially reflective to the light emitted by display 2405, as illustrated by exemplary ray 2504, and substantially transmissive to the light emitted by display 2402. Also, light filter 2404 is partially transparent to the incoming light from the environment outside the device, as exemplified by ray 2502. Corrector element 2501 will correct for the degradation of the image produced by element 2503 so that the image of the surrounding environment seen through the whole device is of a good quality.

In this embodiment, exemplary ray 2504 may be polarized, in which case light filter 2404 reflects the polarization of light ray 2504 and transmits the perpendicular polarization.

In another embodiment, display 2402 emits red, green and blue light (R1, G1, B1) of narrow wavelength ranges and display 2405 emits different red, green and blue light (R2, G2, B2), also of narrow wavelength ranges. Here, light filter 2404 reflects R2, G2, B2 and is transparent to all other wavelengths. This allows R1, G1, B1 emitted by display 2402 as well as the outside light 2502 to pass through. Also, light filter 2407 reflects R1, G1, B1 and is transparent to all other wavelengths. This allows R2, G2, B2 emitted by display 2405 as well as the outside light to pass through. Partial transparency to the light coming from the outside allows the eye to see both the image generated by the optic and the image coming from the outside world.

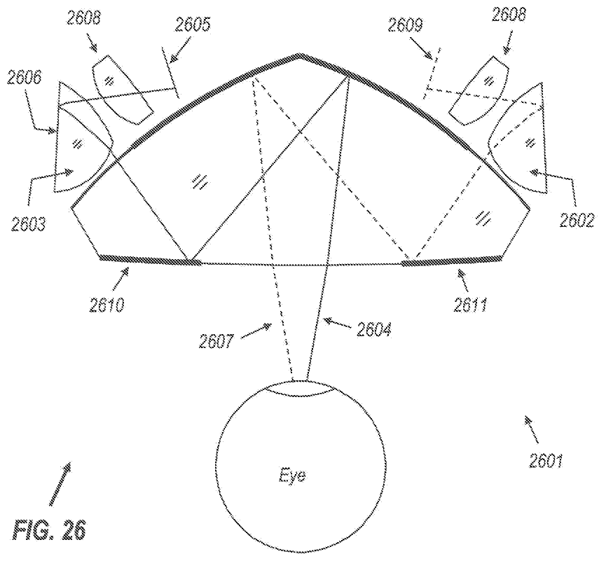

FIG. 26 shows an embodiment 2601 similar to embodiment 2401 shown in FIG. 24. Embodiment 2601 contains folding optics 2602 and 2603. A light ray 2604 emitted from display 2605 will follow its path through the embodiment until reaching the eye. Along the way it is reflected at mirrored surface 2606, which may also work by TIR in some configurations. Light ray 2607 has a symmetrical behavior relative to light ray 2604.

In general, all surfaces of folding optics 2602 and 2603 are curved. For improved image quality, one or more additional optics 2608 may also be included.

In some configurations, additional light filters 2610 and 2611 may be used. Here, light filter 2610 is substantially transmissive to the light emitted by display 2609 and substantially reflective to the light emitted by display 2605. Accordingly, light filter 2611 is substantially transmissive to the light emitted by display 2605 and substantially reflective to the light emitted by display 2609. This prevents failing TIR to occur at these surfaces.

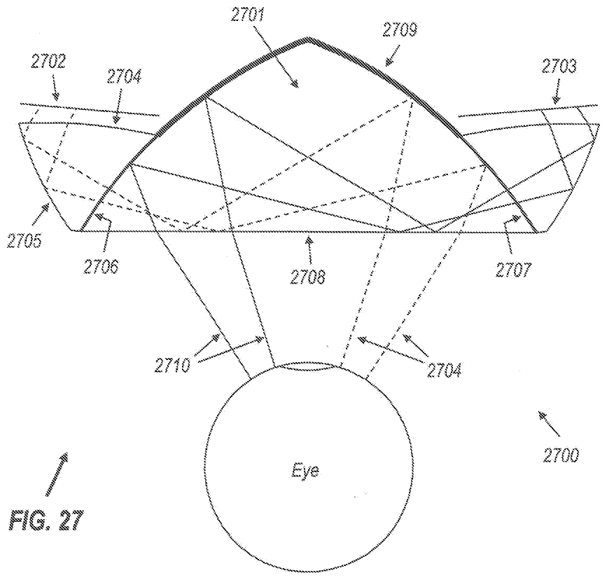

FIG. 27 shows an embodiment 2700 comprising optic 2701 and displays 2702 and 2703. In optic 2701, light filter 2706 is substantially transmissive to the emission of display 2702 and substantially reflective to the emission of display 2703. Also, light filter 2707 is substantially transmissive to the emission of display 2703 and substantially reflective to the emission of display 2702. Light rays 2704 emitted by display 2702 refract into optic 2701 through surface 2704, are reflected at surface 2705 (which may be mirrored or work by TIR), cross light filter 2706, are reflected by TIR at bottom surface 2708 of optic 2701, are reflected either at light filter 2707 or mirror 2709 and refract out of optic 2701 though its bottom surface 2708.

Light rays 2710 emitted by display 2703 have a symmetrical behavior relative to rays 2704 in their path through optic 2701.

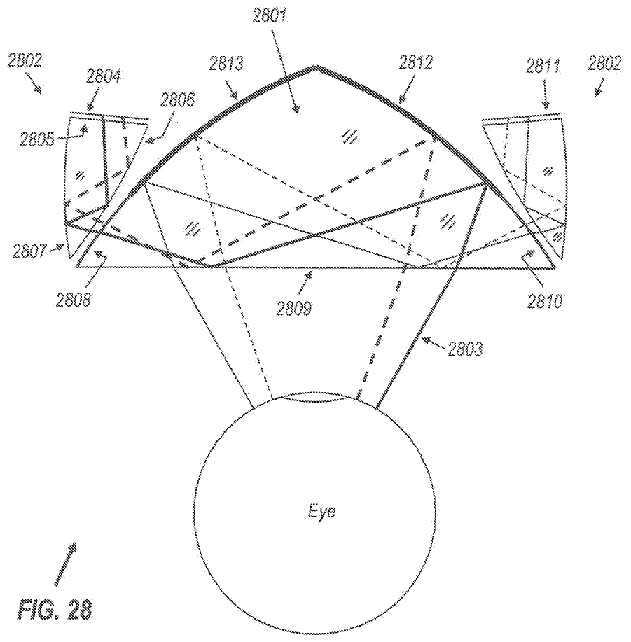

FIG. 28 shows an embodiment comprising central folding optic 2801 and lateral folding optics 2802. An exemplary light ray 2803 emitted from display 2804 refracts into left optic 2802 through surface 2805, it then suffers TIR at surface 2806, is reflected at mirrored surface 2807 and refracts out of optic 2802 through surface 2806. It then enters optic 2801 through light filter 2808, suffers TIR at bottom surface 2809 of optic 2801, is reflected either at mirror 2812 or at light filter 2810 and refracts out of optic 2801 through surface 2809 reaching the eye. In this embodiment, light filter 2808 is substantially transmissive to the light emitted by display 2804 and substantially reflective to the light emitted by display 2811. Also, light filter 2810 is substantially reflective to the light emitted by display 2804 and substantially transmissive to the light emitted by display 2811.

In another configuration, elements 2808 and 2813 are a single light filter with the characteristics described above for 2808. Also, elements 2810 and 2812 are a single light filter with the characteristics described above for 2810.

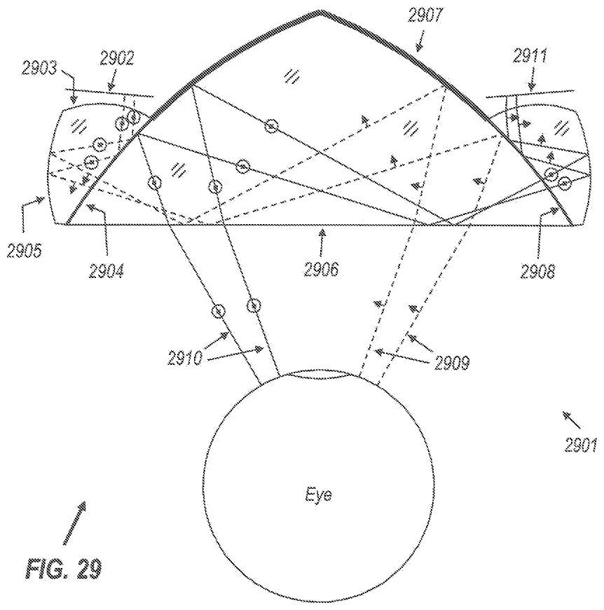

FIG. 29 shows an embodiment 2901 comprising a display 2902 that emits polarized light, for example in the direction perpendicular to the plane of the figure (perpendicular polarization). Exemplary light rays 2909 of said light refract into optic 2901 through surface 2903, then reflect at light filter 2904 that substantially reflects perpendicular polarization and substantially transmits parallel polarization (on the plane of the figure). Said light rays then encounter surface 2905 that as a ¼ wavelength retarder and a mirror behind it that reflects said light rays and rotates their polarization by 90 deg, becoming parallel polarization. Said light rays then cross light filter 2904, suffer TIR at bottom surface 2906 and are again reflected either at mirror 2907 or at light filter 2908 that substantially transmits perpendicular polarization and substantially reflects parallel polarization. Said light finally refracts out of optic 2901 through its bottom surface 2906 and into the eye.

Light rays 2910 emitted from display 2911 have symmetrical interactions with optic 2901, but with perpendicular polarizations.

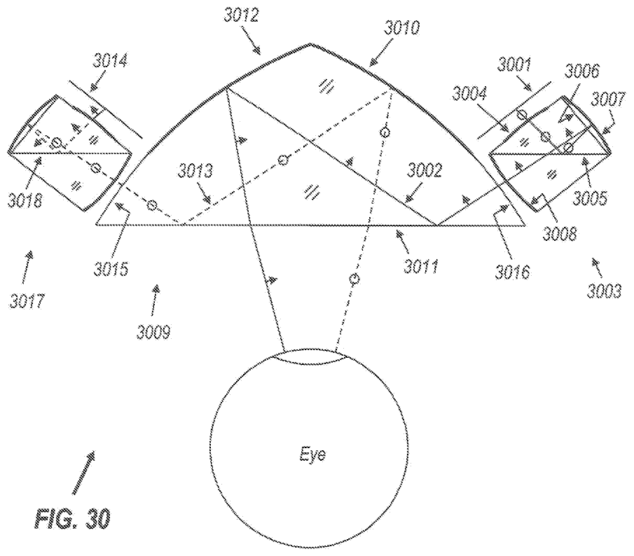

FIG. 30 shows an embodiment comprising displays 3001 and 3014 that emit polarized light (with perpendicular polarizations relative to each other), light filter 3015 that is substantially transmissive to the light emitted by display 3014 after crossing optic 3017 and substantially reflective to the light emitted by display 3001 after crossing optic 3003, light filter 3016 that is substantially transmissive to the light emitted by display 3001 after crossing optic 3003 and substantially reflective to the light emitted by display 3014 after crossing optic 3017, mirrors 3010 and 3012, light filter 3005 that is substantially reflective to polarized light emitted by display 3001 and substantially transmissive to light polarized in the perpendicular direction, and light filter 3018 that is substantially reflective to polarized light emitted by display 3014 and substantially transmissive to light polarized in the perpendicular direction.

In this exemplary configuration display 3001 emits light polarized in the direction perpendicular to the plane of the figure, as illustrated by exemplary ray 3002. This light ray refracts into optic 3003 at surface 3004, is reflected at light filter 3005, crosses ¼ wavelength retarder 3006, is reflected at mirror 3007, crosses again ¼ wavelength retarder 3006 and emerges with its polarization rotated by 90°, which is now on the plane of the figure. It then crosses light filter 3005, refracts out of optic 3003 through surface 3008 and refracts into optic 3009 through light filter 3016. It then suffers TIR at the bottom surface 3011 of optic 3009, is reflected at light filter 3015 or mirror 3012 and refracts out of optic 3009 through its bottom surface 3011, heading towards the eye.

Exemplary ray 3013 emitted from display 3014 has a symmetrical behavior, only with the perpendicular polarization relative to exemplary ray 3002.

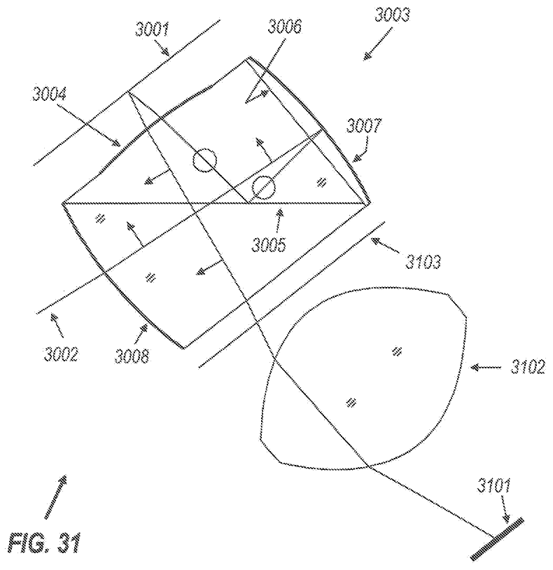

FIG. 31 shows optic 3003 in the case in which display 3001 is a liquid crystal on silicon (LCoS). Light from LED 3101 is collected and collimated by optic 3102 and sent through absorbing polarizer 3103 that absorbs one polarization and transmits the other. This polarized light then crosses polarizer 3005 that transmits one polarization and reflects the other. Said light is then reflected by the LCoS display returning light with a perpendicular polarization that is now reflected at polarizer 3005 towards mirror 3007.

Display 3014 in FIG. 30, being an LCoS, could be illuminated in a similar way.

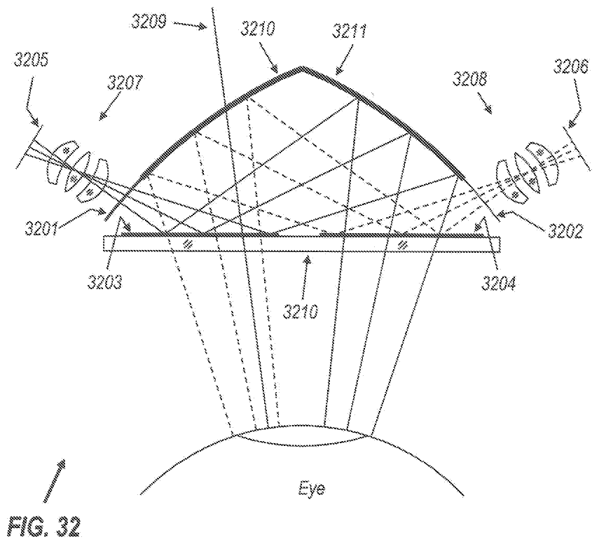

FIG. 32 shows a void embodiment comprising light filters 3201 and 3204 that are substantially transmissive to the emissions of display 3205 and substantially reflective to the emission of displays 3206, and light filters 3202 and 3203 that are substantially transmissive to the emissions of display 3206 and substantially reflective to the emission of displays 3205. In different configurations, elements 3210 and 3211 may be mirrors or partial mirrors. In other configurations elements 3201 and 3210 form a single light filter with the characteristics described for 3201 and elements 3202 and 3211 form a single light filter with the characteristics described for 3202.

Displays 3205 and 3206 emit their light through optical groups 3207 and 3208 respectively. Here, light filters 3203 and 3204 are supported by transparent plate 3210.

In one particular configuration, displays 3205 and 3206 emit polarized light of perpendicular polarizations relative to each other. In that case, light filters 3201 and 3204 substantially transmit the polarization emitted by display 3205 and substantially reflect the polarization emitted by display 3206. Also, light filters 3202 and 3203 substantially transmit the polarization emitted by display 3206 and substantially reflect the polarization emitted by display 3205. Elements 3210 and 3211 may be mirrors or light filters with the characteristics of 3201 and 3202 respectively.

Filters 3203 and 3204 do not touch each other and there is a gap between them.

In another embodiment, elements 3210 and 3211 are partial mirrors allowing some outside light to pass through, as exemplified by ray 3209, allowing the outside world to also be seen.

In another configuration, display 3205 emits light of red, green and blue light (R1, G1, B1) of narrow wavelength ranges and display 3206 emits light of red, green and blue light (R2, G2, B2) of different narrow wavelength ranges. In that case, light filters 3201, 3210 and 3204 substantially reflect wavelengths R2, G2, B2 emitted by display 3206 and substantially transmit all other wavelengths. Also, light filters 3202, 3211 and 3203 substantially reflect wavelengths R1, G1, B1 emitted by display 3205 and substantially transmit all other wavelengths. In this configuration, outside light whose wavelengths are different from R1, G1, B1 and R2, G2, B2 pass through all light filers and allow the outside world to also be seen creating in the eye a superposition of the image from the outside world and the image created by the optical device. This is exemplified by light ray 3209.

In another embodiment elements 3210 and 3211 are mirrors, in which case the outside world will not be visible.

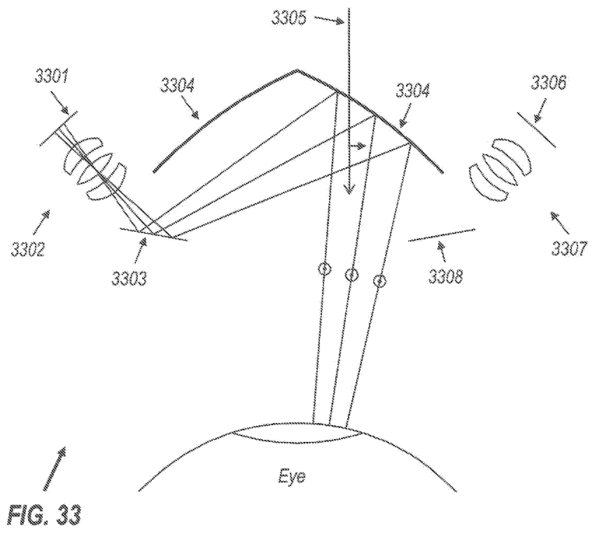

FIG. 33 shows an embodiment comprising display 3301, which may emit unpolarized light, or polarized light polarized (for example) in the direction perpendicular to the plane of the figure. Its light crosses optical group 3302, is reflected at mirror 3303 and again reflected at light filter 3304 towards the eye. Here, light filter 3304 reflects the polarized light emitted by display 3301. Unpolarized light 3305 coming from the surrounding environment will be filtered and only its component on the plane of the figure will cross light filter 3304. The eye will then be able to see the image coming from display 3301 as well as the image of the surrounding environment carried by the component of light 3305 crossing light filter 3304. This embodiment may then be used as a augmented or mixed reality optic.

The light rays emitted by display 3306 have a symmetrical behavior as they progress through the optic, crossing optical group 3307, being reflected at mirror 3308 and again reflected at light filter 3304. It would also be possible for displays 3301 and 3306 to have different polarizations, in which case the two halves of light filter 3304 would also be different.

If light filters 3304 are replaced by mirrors, then outside light 3305 will be blocked by those mirrors 3304 and light 3305 from the surroundings will not be visible. In that case, displays 3301 and 3306 may emit unpolarized light since the whole device works with a combination of lenses and mirrors (refractions and reflections).

In another configuration displays 3301 and 3306 emit red, green and blue light of narrow emission spectra. Component 3304 is a dichroic mirror that reflects these narrow wavelength colors and transmits all other light allowing the outside world to be seen through 3304.

In another configuration, the central optic may be made as a solid block, similarly to the configuration in FIG. 24. In that case mirrors 3303 and 3308 would now be replaced by TIR at the bottom surface of the central optic. That would be a case of the configuration in FIG. 24 in which the light emitted by display 2402 would suffer TIR at the bottom surface 2406 and be redirected towards and reflected only at 2410 and not at 2407. Accordingly, light emitted by display 2405 would suffer TIR at the bottom surface 2406 and be redirected towards and be reflected only at 2411 and not at 2404.

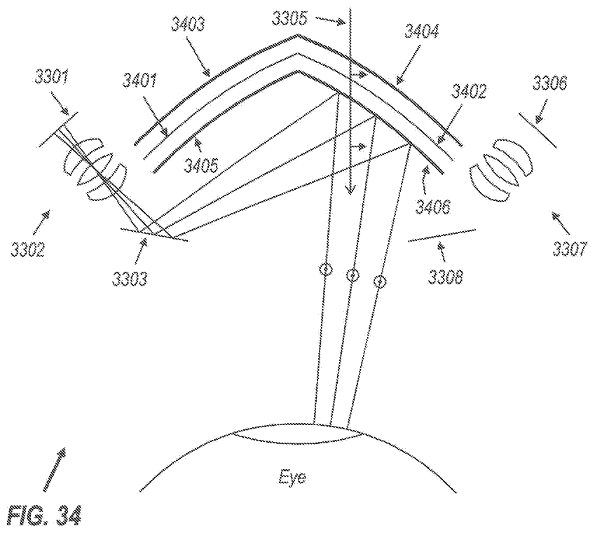

FIG. 34 shows an embodiment similar to that shown in FIG. 33. In this new embodiment, display 3301 emits polarized light (for example) in the direction perpendicular to the plane of the figure (perpendicular polarization). This light is reflected at polarizer 3406 which reflects perpendicular polarization and transmits light linearly polarized on the plane of the figure (parallel polarization). Also included is liquid crystal 3402 and polarizer 3404 that transmits parallel polarization and either absorbs (preferably) or reflects perpendicular polarization.

Liquid crystal 3402 may be in a state in which it transmits parallel polarization, in which case the stack composed of elements 3404, 3402 and 3406 transmit parallel polarization and this light coming from the outside world may reach the eye. Also, liquid crystal may be in a state in which it rotates the polarization of the incoming light by 90°. Now, the transmitted light through the liquid crystal will be reflected at polarizer 3406 preventing it from reaching the eye. Intermediate states are possible for the liquid crystal, in which case the stack composed elements 3404, 3402 and 3406 may vary transmission from full transmission to zero transmission of light with parallel polarization. This may be used, for example, when the outside world is too bright compared to the brightness of the virtual image of displays 3301 or 3306. In that case, the brightness of the outside light may be dimmed to more closely match the brightness of the virtual images.

Commutation of the liquid crystal between different states may be achieved by applying a voltage to said liquid crystal.

In the state in which the outside world can be seen through stack 3404, 3402 and 3406 this embodiment may be used an augmented reality device. In the state in which no outside light crosses stack 3404, 3402 and 3406, this embodiment may be used as a virtual reality device.

Display 3306 may emit the same polarization as display 3301, in which case polarizers 3405 and 3403 are the same as 3406 and 3404. In an alternative embodiment, displays 3301 and 3306 emit light whose polarizations are perpendicular to each other and polarizers 3405 and 3403 are different from 3406 and 3404.

In another configuration, part of the area of stacks 3403, 3401, 3405 or 3404, 3402, 3406 may be set to partial or total transmission of polarized light and the remaining area set to block incoming light. This allows the selective transmission or blockage of incoming light from the outside world, which may be used to adjust the brightness of incoming light coming from different directions. In another configuration, this selective transmission of incoming light may be combined with eye tracking.

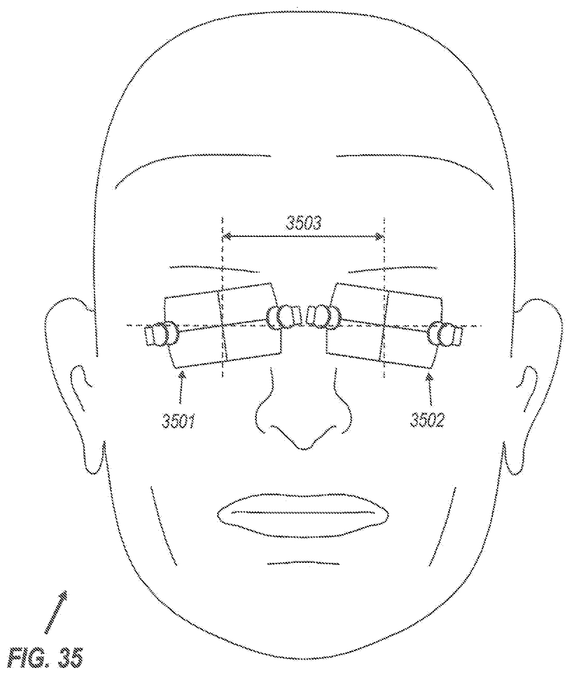

FIG. 35 shows optics 3501 and 3502 which may be similar to those in FIG. 24 or FIG. 33. When adjusting the pupillary distance 3503, the displays of these embodiments may touch each other. In order to avoid that, optics 3501 and 3502 may be tilted relative to the horizontal so that the displays and corresponding optical groups will now be further apart when adjusting for small pupillary distances 3503.

In this configuration optic 3501 is rotated counterclockwise and optic 3502 is rotated clockwise relative to the horizontal. In another configuration optic 3501 is rotated counterclockwise and optic 3502 is also rotated counterclockwise relative to the horizontal. In that case the right display of optic 3501 would be up and the left display of 3502 would be down, and they would pass past each other when adjusting the pupillary distance.

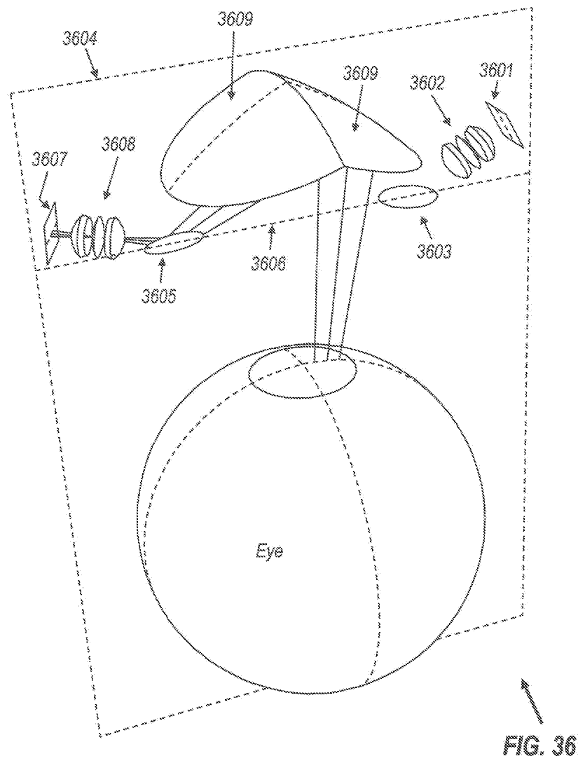

FIG. 36 shows a perspective view of an embodiment similar to that shown in FIG. 33. Display 3601, optical group 3602, mirror 3603 and light filter 3609 are symmetrical relative to plane 3604. Mirror 3605 is rotated around axis 3606 leading to a rotation of display 3607 and optical group 3608 that are no longer symmetrical relative to plane 3604.

In general, mirror 3605 may be oriented in any convenient direction, adjusting the orientation of display 3607 and optical group 3608.

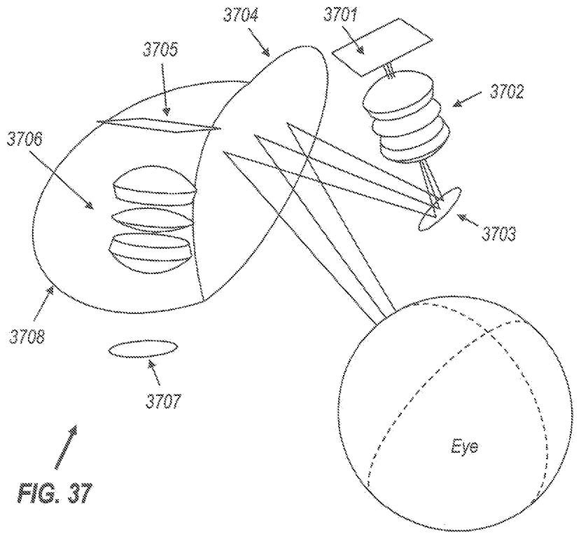

FIG. 37 shows an embodiment similar to that shown in FIG. 33. Light emitted from display 3701 crosses optical group 3702, is reflected at mirror 3703 and again reflected at light filter or mirror 3704 towards the eye. Another channel for image formation starts at display 3705, crosses optical group 3706, reflects at mirror 3707 and then at light filter or mirror 3708 towards the eye.

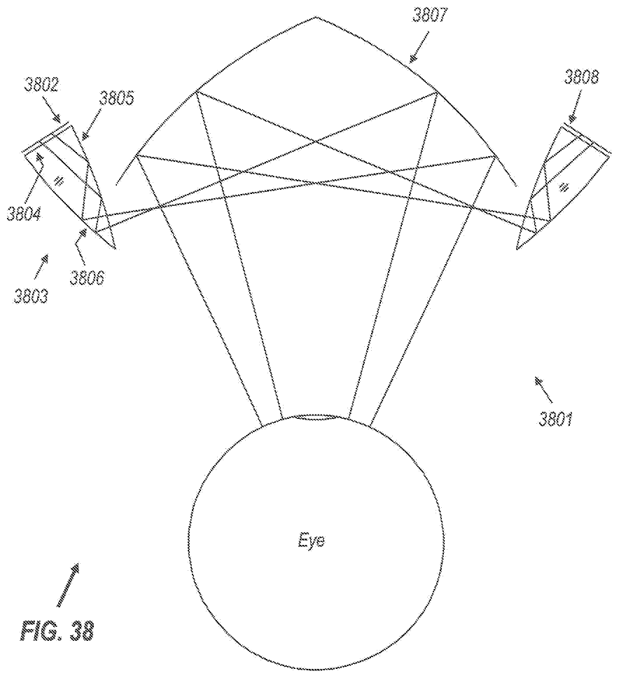

FIG. 38 shows an embodiment similar to that in FIG. 33. This new embodiment 3801 comprises a display 3802 whose emission refracts into side optic 3803 through its surface 3804. It is then reflected by TIR at surface 3805, again reflected at mirrored surface 3806 and refracts out of side optic 3803 through its surface 3805. This light is then reflected at mirror or light filter 3807 towards the eye. The emission from display 3808 has a symmetrical behavior relative to the emission of display 3802.

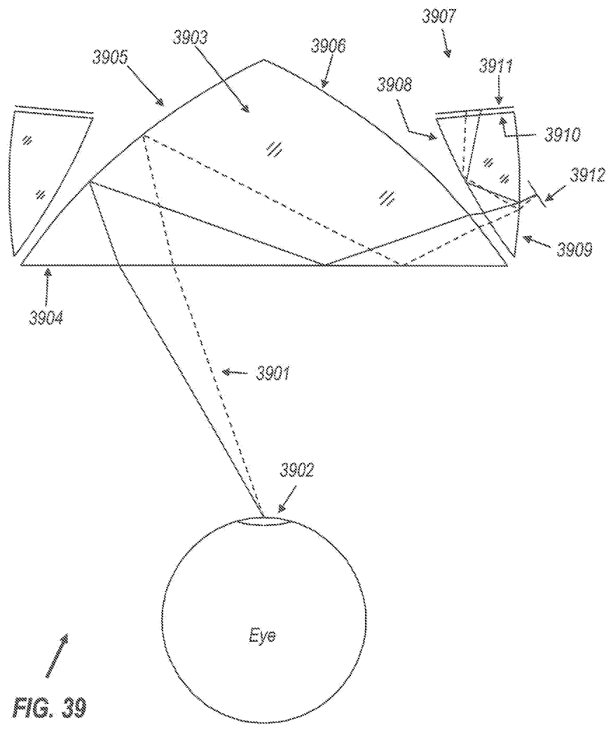

FIG. 39 shows an embodiment in which a light ray 3901 emitted in reverse direction from eye pupil 3902 refracts into optic 3903 through its bottom surface 3904, it is then reflected at the top surface 3905, suffers TIR at bottom surface 3904 and refracts out of optic 3903 through surface 3906. It then refracts into side optic 3907 through its surface 3908, is reflected at surface 3909, suffers TIR at surface 3908 and refracts out of side optic 3907 through its surface 3910, reaching display 3911.

In a preferred embodiment, surface 3909 is partially transmissive and an image of the eye pupil 3902 is formed on sensor 3912. Said image may be used to track the movement of the eye.

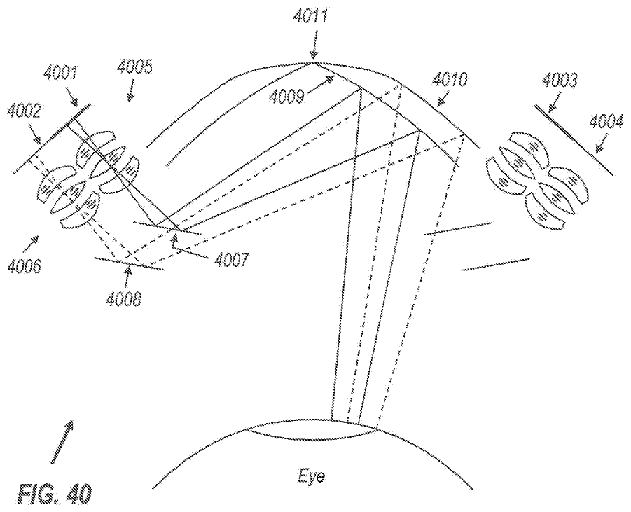

FIG. 40 shows an embodiment comprising displays 4001 and 4002, optical groups 4005 and 4006, light filters 4007 and 4009 and mirrors 4008 and 4010. Here, light filters 4007 and 4009 are substantially reflective to the light emitted by display 4001 and substantially transmissive to the light emitted by display 4002. Elements 4009 and 4010 touch at vertex 4011.

The light emitted by display 4001 crosses optical group 4005, is reflected at light filter 4007 and then at 4009 towards the eye. The light emitted by display 4002 crosses optical group 4006, is reflected at mirror 4008, crosses light filters 4007 and 4009, is reflected at mirror 4010 and again crosses light filters 4009 on its way towards the eye.

In another configuration, the light emitted by display 4001 is reflected at element 4010 and the light emitted by display 4002 is reflected at element 4009. In such a configuration, light filter 4009 is substantially reflective to the light emitted by display 4002 and substantially transmissive to the light emitted by display 4001.

Stacked reflectors 4009 and 4010 are spaced or use spacers to separate them.

In 3D configurations, the relative orientations of displays 4001 and 4002 and corresponding optical groups 4005 and 4006 may vary, by reorienting elements 4007 and 4008.

The virtual image of display 4001 will be placed at a distance d₁ from the eye while the virtual image of display 4002 will be placed at another distance d₂ from the eye. Display 4001 will lit pixels whose corresponding 3D points are closest to distance d₁ from the eye, while display 4002 will lit pixels whose corresponding 3D points are closest to distance d₂ from the eye, reducing the convergence-accommodation mismatch.

In another configuration, display 4001 emits light of red, green and blue light (R1, G1, B1) of narrow wavelength ranges and display 4002 emits light of red, green and blue light (R2, G2, B2) of different narrow wavelength ranges. In that case, element 4010 is a light filter that substantially reflects wavelengths R2, G2, B2 emitted by display 4002 and substantially transmits all other wavelengths. Also, light filters 4007 and 4009 substantially reflect wavelengths R1, G1, B1 emitted by display 4001 and substantially transmit all other wavelengths. In this configuration, outside light whose wavelengths are different from R1, G1, B1 and R2, G2, B2 pass through all light filers and allow the outside world to also be seen creating in the eye a superposition of the image from the outside world and the image created by the optical device. This results in a multi-channel, multi-focal see-through embodiment.

Optical groups 4005 and 4006 can be two separate optics or a two-channel system as described in PCT1.

The whole embodiment is essentially symmetric and the paths of light emitted by displays 4003 and 4004 are essentially symmetric to the paths of light emitted by displays 4001 and 4002. In other configurations, the relative orientations of the elements to the left and right may vary.

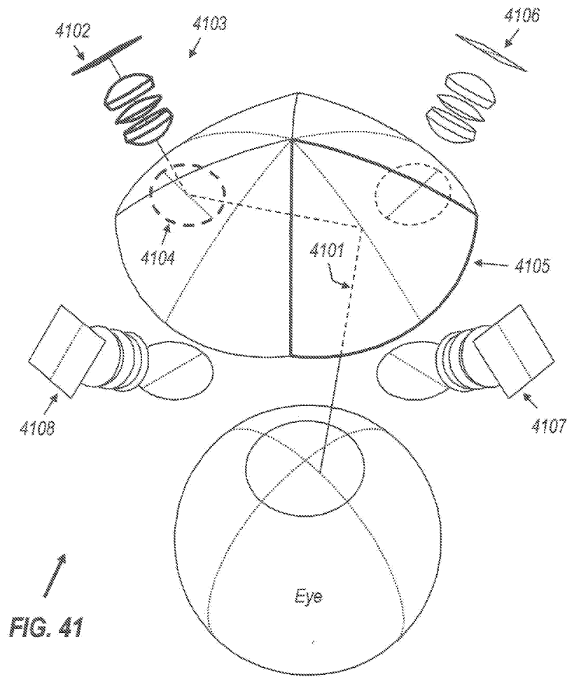

FIG. 41 shows a four-fold embodiment whose cross section is similar to that shown in FIG. 33. Exemplary light ray 4101 emitted from display 4102 crosses optical group 4103, is reflected at mirror 4104 and then at mirror 4105 towards the eye. Light rays emitted from displays 4106, 4107, 4108 have similar but symmetrical paths.

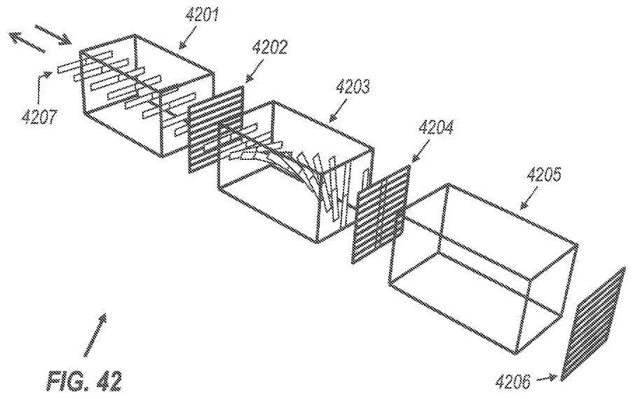

FIG. 42 shows a stack composed of liquid crystals 4201, 4203 and 4205 and reflective polarizers 4202, 4204 and 4206. In this example, said reflective polarizers transmit horizontal polarization and reflect vertical polarization. Also in this example liquid crystal 4201 allows polarized light 4207 to pass through from left to right reaching reflective polarizer 4202 which also transmits the light to liquid crystal 4203 that rotates the polarization of the light by 90°. Said light is then reflected at reflective polarizer 4204, again crossing liquid crystal 4203 that rotates the polarization back to its original orientation, crossing reflective polarizer 4202 and liquid crystal 4201, exiting the stack from right to left. In this example, the whole stack behaves as a mirror 4204. Depending on what liquid crystal 4201, 4203 or 4205 rotates the polarization of the light, said light will be reflected at reflective polarizers 4202, 4204 or 4206 respectively. If all liquid crystal layers are set to state 4201, the whole stack will transmit the incoming light. Commutation of the liquid crystal between states 4201 and 4203 is achieved by applying a voltage to the liquid crystal.

In general, this stack may have any number of pairs, each pair composed of a liquid crystal and a reflective polarizer. Any of the liquid crystal layers or reflective polarizer layers may be flat or curved.

The rotation of polarization introduced by a liquid crystals may vary, varying the amount of light reflected at the next polarizer.

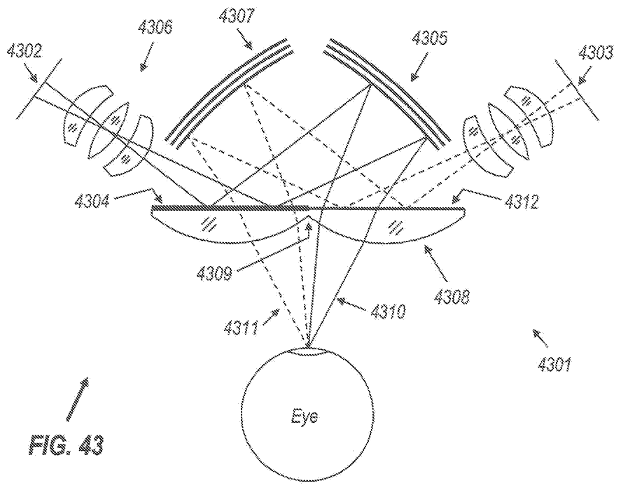

FIG. 43 shows an embodiment 4301. Two of these embodiments are used, one for the left eye and one for the right eye, to present 3D images to the viewer. Embodiment 4301 comprises displays 4302 and 4303 that emit polarized light in directions perpendicular to each other.

As exemplified by light ray 4310, light emitted from display 4302 crosses optical group 4306 and is reflected at light filter 4304 that is substantially reflective to the light emitted by display 4302 and substantially transmissive to the light emitted by display 4303. Said light is then reflected at stack 4305 and refracted into lens 4308 through light filter 4312 that is substantially transmissive to the light emitted by display 4302 and substantially reflective to the light emitted by display 4303. Light ray 4310 then refracts out of bottom lens 4308 reaching the eye. The emission of display 4303 has a symmetrical behavior, as exemplified by light ray 4311, and is reflected at stack 4307.

The elements in commutable stacked reflectors (stack) 4305 or 4307 are spaced or use spacers to separate them.

Lens 4308 has a slope discontinuity 4309 that separates the left and right channels for the light emitted from displays 4302 and 4303.

The structure of stacks 4305 or 4307 is as shows in FIG. 42. The polarizers in stack 4305 are substantially transmissive to the light emitted by display 4302 and substantially reflective to its perpendicular polarization. The polarizers in stack 4307 are substantially transmissive to the light emitted by display 4303 and substantially reflective to its perpendicular polarization. Reflection of light from display 4302 at different reflective polarizers p₁, p₂, p₃, . . . in stack 4305 results in virtual images of display 4302 at different distances d₁, d₂, d₃, . . . from the eye. As the stack commutes between reflection at p₁, p₂, p₃, . . . display 4302 will lit the pixels corresponding to 3D points (ipixel) closer to distances d₁, d₂, d₃, . . . reducing the convergence-accommodation mismatch.

In another configuration, a virtual image is generated at a distance d₁ with a brightness b₁ and another (later) virtual image is generated at a distance d₂ with a brightness b₂, both of the of the same 3D points (ipixels). The varying brightness of the virtual images results from a varying brightness of the displays. By varying the brightness of the images projected at distances d₁ and d₂, the resulting content will appear to be positioned between distances d₁ and d₂.

In another embodiment, stacks 4305 and 4307 are replaced by mirrors in which case the virtual images of displays 4302 and 4303 are formed at a fixed distance.

Some users of these devices may need glasses to correct eye sight. In such cases stacks 4302 may be used to project virtual images at a distance visible to the user reducing or eliminating the need to wear additional correction lenses.

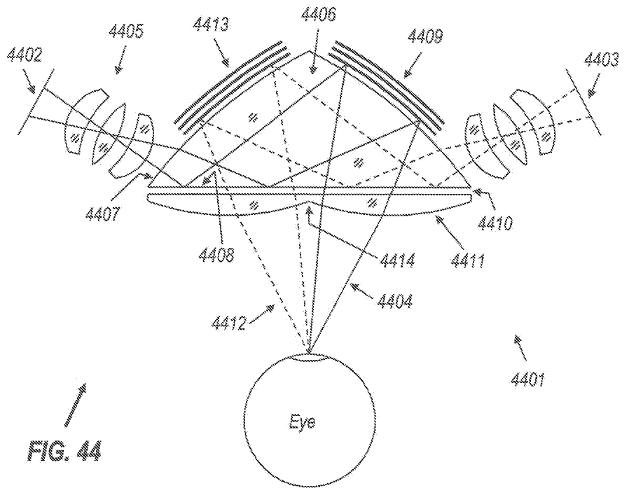

FIG. 44 shows an embodiment 4401 comprising two displays 4402 and 4403. Emission of display 4402, as exemplified by ray 4404, crosses optical group 4405, refracting into optic 4406 through surface 4407. It then suffers TIR at bottom surface 4408 of optic 4406, is reflected at stack 4409, refracts out of optic 4406 through its bottom surface 4408 and crosses air gap 4410 and bottom lens 4411 reaching the eye. The emission of display 4403 has a symmetrical behavior, as exemplified by light ray 4412, and is reflected at stack 4413. Lens 4411 has a slope discontinuity 4414 that separates the left and right channels for the light emitted from displays 4402 and 4403.

The structure of stack 4409 is as shows in FIG. 42 and similar to stack 4305 in FIG. 43. Reflection of light from display 4402 at different reflective polarizers p₁, p₂, p₃, . . . in stack 4409 results in virtual images of display 4402 at different distances d₁, d₂, d₃, . . . from the eye. As the stack commutes between reflection at p₁, p₂, p₃, . . . display 4402 will lit the pixels corresponding to 3D points closer to distances d₁, d₂, d₃, . . . reducing the convergence-accommodation mismatch.

In another embodiment, optics 4406 and 4411 form a single component united by a low refractive index material. In another embodiment, stacks 4409 and 4413 are replaced by mirrors in which case the virtual images of displays 4402 and 4403 are formed at a fixed distance.

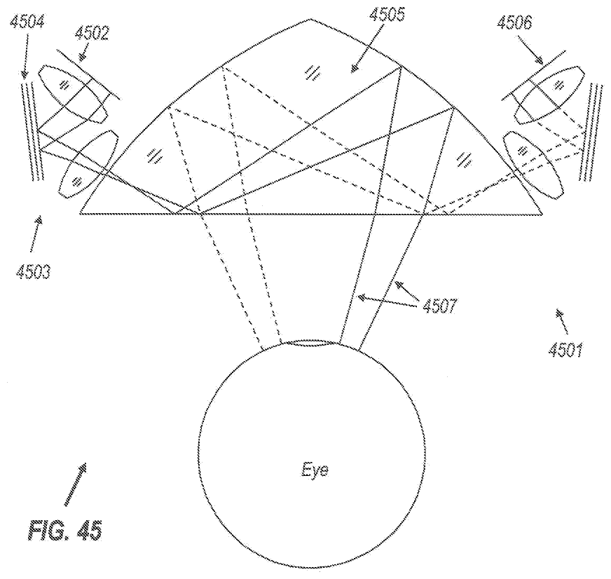

FIG. 45 shows an embodiment 4501 similar to that shown in FIG. 26. The light emitted from display 4502 crosses an optical group 4503 containing a stack 4504, then enters optic 4505 from which it is redirected to the eye, as exemplified by the paths or light rays 4507. Reflection of light at different optical surfaces in stack 4504 allows the embodiment 4501 to generate virtual images at different distances that may be used to reduce the convergence-accommodation mismatch, as was the case in the embodiments of FIG. 43 or FIG. 44.

The light emitted from display 4506 has a symmetrical behavior relative to that emitted by display 4502.

Detailed Example of a Prism (with Light Polarizers and Retarders) that Works with Two Displays

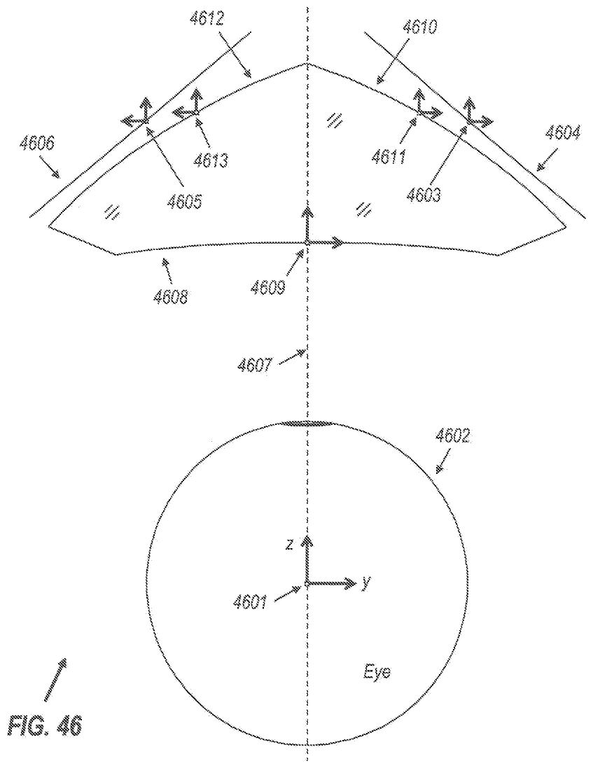

This section describes in greater detail the optical design for the embodiment previously described in FIG. 5 or one of its variants. The embodiment shown in FIG. 46 consists of one prism lens made of Zeonex 48R where rays suffer 4 deflections on 3 freeform surfaces (1 optical surface is used twice) and two displays with 16:10 aspect ratio and 1.8″ diagonal. The optical design is done by multiparameter optimization of the coefficients of a polynomial expansion, preferably using an orthogonal basis. In the embodiment described herein, surfaces are described with the following equation:

$$Pm ( x , y ) = {\sum }_{i = 0}^{\frac{m}{2}} {\sum }_{j = 0}^{m} {c}_{2 i , j} {P}_{2 i} ( \frac{x - \frac{{x}_{max} + {x}_{min}}{2}}{{x}_{max}} ) {P}_{j} ( \frac{y - \frac{{y}_{max} + {y}_{min}}{2}}{{y}_{max}} )$$

where Pm(x,y) is the 10^{th} order polynomial, i.e. m=10, c_{2,j} are the optimized surface coefficients listed in Table 1 below, and P₂ᵢ((x−(xₘₐₓ+xₘᵢₙ)/2)/xₘₐₓ) and Pⱼ((y−(yₘₐₓ+yₘᵢₙ)/2)/yₘₐₓ) are Legendre polynomials that are orthogonal inside of the area restricted with xₘᵢₙ and xₘₐₓ, yₘᵢₙ and yₘₐₓ in x and y directions, respectively. All surfaces have plane symmetry in yz-plane, i.e., the plane x=0 (plane of the drawing shown in FIG. 46) so the Legendre polynomial P₂ᵢ((x−(xₘₐₓ+xₘᵢₙ)/2)/xₘₐₓ) has only even order monomials. One of the prism surfaces (the one closest to the human eye) has plane symmetry in both xz and yz-planes, so in this case Legendre polynomial Pⱼ((y−(yₘₐₓ+yₘᵢₙ)/2)/yₘₐₓ) has only even monomials as well.

Explicit representation of Legendre polynomials includes:

$${P}_{n} ( x ) = \frac{1}{{2}^{n}} {\sum }_{k - 0}^{n} {( \begin{matrix}n \\ k\end{matrix} )}^{2} {( x - 1 )}^{n - k} {( x + 1 )}^{k} = {2}^{n} {\sum }_{k = 0}^{n} {x}^{k} ( \begin{matrix}n \\ k\end{matrix} ) ( \begin{matrix}\frac{n + k - 1}{2} \\ n\end{matrix} )$$

where the latter expresses the Legendre polynomials by simple monomials and involves the multiplicative formula of the binomial coefficient, and where

$$( \begin{matrix}n \\ k\end{matrix} ) = \frac{n !}{k ! ( n - k ) !} .$$

FIG. 46 shows local coordinate system of each surface polynomial description in the yz-plane, x=0 (where the z-axis points up and the y-axis points right). The eye sphere center is at position 4601 and we use it as the center of the global coordinate system (x,y,z)=(0,0,0).The eye sphere is labeled as 4602. Local coordinate system origin 4603 used for display 4604 has coordinates (x,y,z)=(0,13.0677629,37.1086837). The local coordinate system with origin 4605 for the second digital display 4606 is placed at (x,y,z)=(0,−13.0677629,37.1086837). Digital display 4606 is a mirror image of the digital display 4604 with respect to the plane y=0 of the global coordinate system that contains axis 4607. Both digital displays 4604 and 4606 are tilted 39.8535 degrees in the yz-plane around the x-axis of their local coordinate systems. The rotation is left-handed about the x axis (note that the y axes of the local coordinate systems centered at 4603 and 4611 point right while the y axes of the local coordinate systems centered at 4605 and 4613 point left). Surface 1 is labeled as 4608 and its local coordinate origin 4609 is placed at (x,y,z)=(0,0,27.37859755021159291477). Surface 2 is labeled as 4610 and its local coordinate origin 4611 is placed at (x,y,z)=(0,8.9605,37.8051267). Surface 2 is tilted 36.04414070202 degrees in the yz-plane around the x-axis of its local coordinate system. Once more the rotation is left-handed about the x axis. Surface 3 labeled as 4612 is a mirror image of Surface 2 respect to the y=0 global coordinate system plane. Polynomial representation of Surface 3 in its local coordinate system 4613 is equivalent to the representation of Surface 2 in its local coordinate system 4611. Surface 3 tilt is equivalent to the tilt of Surface 2, each one performed in its own local system. Coordinates are given in mm. Coefficients of all surfaces' polynomials are listed in Table 1. The first four rows are C1: xₘᵢₙ, C2: xₘₐₓ, C3: yₘᵢₙ and C4: yₘₐₓ that describe a rectangular area between xₘᵢₙ and xₘₐₓ in the x-direction, and yₘᵢₙ and yₘₐₓ in the perpendicular y-direction where each polynomial is orthogonal. The next rows C5 to C117 of Table 1 are coefficients of 10^{th} order Legendre polynomial Pm(x,y) for each surface designed for this embodiment. As Surface 3 is a mirror image of Surface 2 with respect to the plane y=0 in a global coordinate system representation, Surface 3 will have coefficients with odd j in Pⱼ((y−(yₘₐₓ+yₘᵢₙ)/2)/yₘₐₓ) with changed sign in comparison with Surface 2. The remaining coefficients are identical. Surface1 has plane symmetry relative to both xz and yz-planes (respectively, x=0 and y=0 planes), while Surface 2 and consequently Surface 3 have plane symmetry only relative to plane x=0. The coefficients that do not appear in Table 1 are equal to zero.

TABLE 1

| Parameter | Surface 1 | Surface 2 |
|---|---|---|
| C1: xₘᵢₙ | −18. | −24. |
| C2: xₘₐₓ | 18. | 24. |
| C3: yₘᵢₙ | −15.5 | −15. |
| C4: yₘₐₓ | 15.5 | 15. |
| C5: c00 | −1.640042018751624 | −3.29823204472949 |
| C6: c01 | 0 | 1.88542354111384 |
| C7: c02 | −1.1904699970753312 | −1.81166579398354 |
| C8: c03 | 0 | −0.0283133554585642 |
| C9: c04 | −0.10923069166038013 | −0.0696085357843656 |
| C10: c05 | 0 | 0.00915665903260706 |
| C11: c06 | 0.03634677340502685 | 0.000586808645216842 |
| C12: c07 | 0 | 0.00881892215765322 |
| C13: c08 | 0.046387139670642175 | −0.00352430312163475 |
| C14: c09 | 0 | −0.000776475231656924 |
| C15: c010 | 0.019578917315160184 | −0.00334374071710514 |
| C27: c20 | −2.5684726434981378 | −5.03692762887083 |
| C28: c21 | 0 | 0.163145818390019 |
| C29: c22 | −1.0531702634260718 | −0.524879466736276 |
| C30: c23 | 0 | −0.0187508001547588 |
| C31: c24 | 0.026787438372126084 | −0.0282472727925326 |
| C32: c25 | 0 | 0.00490422044667506 |
| C33: c26 | 0.16820742851444953 | 0.0107746864819972 |
| C34: c27 | 0 | −0.018748420190004 |
| C35: c28 | 0.16445909974121925 | −0.00266785123324015 |
| C36: c29 | 0 | −0.005494105727798 |
| C37: c210 | 0.04075171197266294 | −0.00271118352719395 |
| C49: c40 | 0.21788889124865457 | 0.0687721726644894 |
| C50: c41 | 0 | 0.31263906568566 |
| C51: c42 | 0.06190568836762725 | 0.0433968081173537 |
| C52: c43 | 0 | 0.0253606090979158 |
| C53: c44 | 0.13411491207936826 | −0.00867494455176321 |
| C54: c45 | 0 | −0.0221104180816908 |
| C55: c46 | 0.11270215455225154 | −0.00919523473492672 |
| C56: c47 | 0 | −0.00551732176589778 |
| C57: c48 | 0.04050021436737846 | 0.00179036975038864 |
| C59: c410 | 0.00585366974578655 | 0.0687721726644894 |
| C71: c60 | 0.04255638663670218 | 0.0613073487900375 |
| C72: c61 | 0 | 0.054079181161532 |
| C73: c62 | −0.04236459834116329 | −0.000679800513815614 |
| C74: c63 | 0 | −0.012180887519139 |
| C75: c64 | −0.06816791561571289 | −0.00320261066524358 |
| C77: c66 | −0.021988974142430937 | 0 |
| C79: c68 | 0.0036007824411837777 | 0 |
| C93: c80 | −0.031178824160881625 | 0.00671240050318829 |
| C94: c81 | 0 | −0.000803936931381883 |
| C95: c82 | −0.061243456760009515 | 0 |
| C97: c84 | −0.018842462548442945 | 0 |
| C99: c86 | −0.011034749822030523 | 0 |
| C101: c88 | 0.0003139727186720883 | 0 |
| C115: c100 | −0.0023349425083774274 | 0.00128351188150982 |
| C117: c102 | −0.0010583224578888722 | 0 |

Table 2 and Table 3 show the root-mean-square (RMS) diameters of the polychromatic spots for some selected fields of the design in FIG. 46 using a pupil diameter of 4 mm. This design has a focal length of about 22 mm. The horizontal field of view is 100 degrees and vertical field of view is 110 degrees for two 1.8″ (45.72 mm) diagonal 16:10 displays per eye. Angles χ and y in the table have the same definitions as in Paragraph [0160] of PCT Publication WO 2016118643 A1 Display device with total internal reflection, which publication is incorporated herein by reference in its entirety.

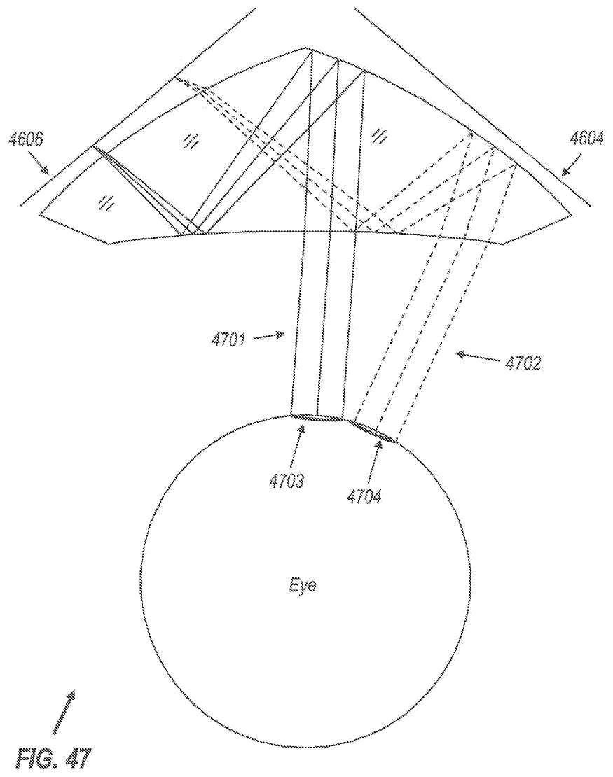

Table 2 corresponds to the situation shown in FIG. 47 when the eye is gazing said field, so the peripheral angle for the human eye perception is 0 for all the fields, and thus the optical resolution should be the maximum for this field. Table 2 shows that opixels as small as 20-30 microns can be resolved well, although the RMS diameter increases for the highest values of the angle χ (deg).

FIG. 47 shows the embodiment shown in FIG. 46. Also shown are two exemplary pupil orientations 4703 and 4704 of the eye gazing in the directions of incoming rays 4701 or 4702 respectively. The eye has high resolution in these gazing directions, so the image quality must be good for rays 4701 and 4702.

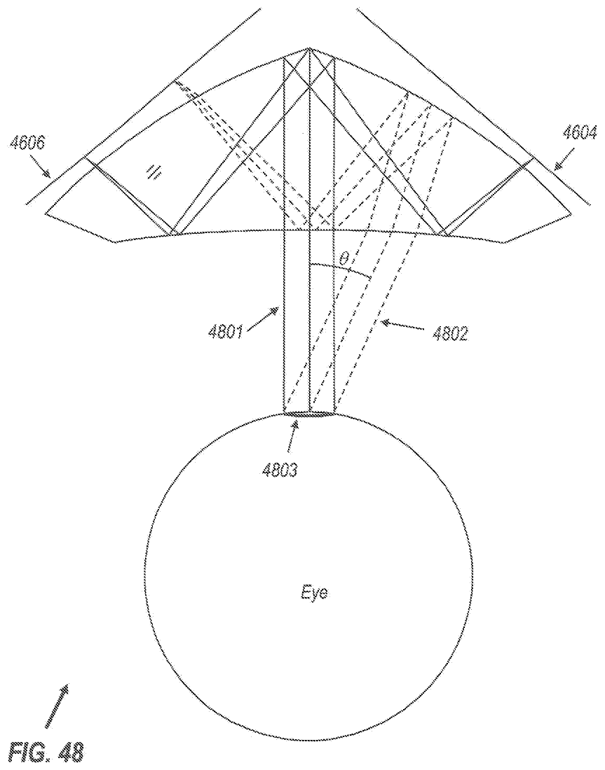

Table 3 corresponds to the situation shown in FIG. 48 when the eye is gazing frontwards, so the peripheral angle for the human eye perception is not zero, but equal to a Therefore, the optical resolution can be lower without affecting the human perception of optical quality. For this reason, the RMS values are much higher in Table 3 than in Table 2 for the same fields.

FIG. 48 shows the same embodiment shown in FIG. 46. Here the eye is gazing frontwards, in the direction of incoming rays 4801, as indicated by pupil position 4803. The eye will also see a peripheral image in the direction of incoming rays 4802 that reach the eye at an angle θ to the gazing direction. The eye resolution for this peripheral field 4802 is lower than that for field 4801. The image quality for rays 4802 may then be lower than for rays 4801.

TABLE 2

| χ (deg) | γ (deg) | RMS (μm) |
|---|---|---|
| 0 | 0 | 21.0 |
| 0 | 2 | 19.2 |
| 0 | 4 | 19.2 |
| 0 | 6 | 17.7 |
| 0 | 8 | 22.6 |
| 0 | 10 | 25.9 |
| 0 | 12 | 26.8 |
| 0 | 14 | 28.9 |
| 0 | 16 | 32.8 |
| 0 | 18 | 36.3 |
| 0 | 20 | 37.8 |
| 0 | 22 | 37.4 |
| 0 | 24 | 34.1 |
| 0 | 26 | 33.4 |
| 0 | 28 | 41.2 |
| 0 | 30 | 61.0 |
| 2 | 0 | 20.7 |
| 2 | 2 | 20.0 |
| 2 | 4 | 19.9 |
| 2 | 6 | 18.2 |
| 2 | 8 | 22.6 |
| 2 | 10 | 25.7 |
| 2 | 12 | 26.5 |
| 2 | 14 | 28.7 |
| 2 | 16 | 32.7 |
| 2 | 18 | 36.1 |
| 2 | 20 | 37.4 |
| 2 | 22 | 36.8 |
| 2 | 24 | 33.8 |
| 2 | 26 | 33.8 |
| 2 | 28 | 42.9 |
| 2 | 30 | 63.9 |
| 4 | 0 | 20.0 |
| 4 | 2 | 22.0 |
| 4 | 4 | 21.6 |
| 4 | 6 | 19.4 |
| 4 | 8 | 22.7 |
| 4 | 10 | 25.2 |
| 4 | 12 | 25.7 |
| 4 | 14 | 28.3 |
| 4 | 16 | 32.5 |
| 4 | 18 | 35.6 |
| 4 | 20 | 36.1 |
| 4 | 22 | 35.1 |
| 4 | 24 | 33.3 |
| 4 | 26 | 34.8 |
| 4 | 28 | 48.0 |
| 4 | 30 | 74.3 |
| 6 | 0 | 20.3 |
| 6 | 2 | 24.5 |
| 6 | 4 | 23.9 |
| 6 | 6 | 21.0 |
| 6 | 8 | 22.9 |
| 6 | 10 | 24.5 |
| 6 | 12 | 24.9 |
| 6 | 14 | 28.0 |
| 6 | 16 | 32.6 |
| 6 | 18 | 35.1 |
| 6 | 20 | 34.2 |
| 6 | 22 | 32.8 |
| 6 | 24 | 33.3 |
| 6 | 26 | 38.0 |
| 6 | 28 | 55.7 |
| 6 | 30 | 86.8 |
| 8 | 0 | 22.4 |
| 8 | 2 | 26.9 |
| 8 | 4 | 25.8 |
| 8 | 6 | 22.3 |
| 8 | 8 | 22.8 |
| 8 | 10 | 23.7 |
| 8 | 12 | 24.4 |
| 8 | 14 | 28.4 |
| 8 | 16 | 33.4 |
| 8 | 18 | 35.2 |
| 8 | 20 | 32.2 |
| 8 | 22 | 30.3 |
| 8 | 24 | 33.0 |
| 8 | 26 | 41.9 |
| 8 | 28 | 63.2 |
| 8 | 30 | 102.6 |
| 10 | 0 | 26.0 |
| 10 | 2 | 28.6 |
| 10 | 4 | 27.0 |
| 10 | 6 | 23.1 |
| 10 | 8 | 22.6 |
| 10 | 10 | 23.1 |
| 10 | 12 | 24.6 |
| 10 | 14 | 29.8 |
| 10 | 16 | 35.2 |
| 10 | 18 | 35.1 |
| 10 | 20 | 30.5 |
| 10 | 22 | 29.2 |
| 10 | 24 | 33.6 |
| 10 | 26 | 44.9 |
| 10 | 28 | 68.6 |
| 10 | 30 | 116.1 |
| 12 | 0 | 29.7 |
| 12 | 2 | 29.1 |
| 12 | 4 | 27.2 |
| 12 | 6 | 23.0 |
| 12 | 8 | 22.0 |
| 12 | 10 | 22.3 |
| 12 | 12 | 25.5 |
| 12 | 14 | 32.1 |
| 12 | 16 | 37.5 |
| 12 | 18 | 36.4 |
| 12 | 20 | 29.9 |
| 12 | 22 | 26.8 |
| 12 | 24 | 33.5 |
| 12 | 26 | 45.4 |
| 12 | 28 | 69.8 |
| 12 | 30 | 125.6 |
| 14 | 0 | 31.4 |
| 14 | 2 | 28.3 |
| 14 | 4 | 26.4 |
| 14 | 6 | 22.1 |
| 14 | 8 | 20.6 |
| 14 | 10 | 22.0 |
| 14 | 12 | 26.4 |
| 14 | 14 | 34.4 |
| 14 | 16 | 40.0 |
| 14 | 18 | 38.4 |
| 14 | 20 | 30.8 |
| 14 | 22 | 26.7 |
| 14 | 24 | 32.5 |
| 14 | 26 | 43.5 |
| 14 | 28 | 66.7 |
| 14 | 30 | 128.0 |
| 16 | 0 | 31.2 |
| 16 | 2 | 26.4 |
| 16 | 4 | 24.9 |
| 16 | 6 | 20.7 |
| 16 | 8 | 19.4 |
| 16 | 10 | 22.2 |
| 16 | 12 | 27.8 |
| 16 | 14 | 36.3 |
| 16 | 16 | 42.1 |
| 16 | 18 | 41.3 |
| 16 | 20 | 33.3 |
| 16 | 22 | 29.1 |
| 16 | 24 | 33.2 |
| 16 | 26 | 41.3 |
| 16 | 28 | 62.3 |
| 16 | 30 | 123.0 |
| 18 | 0 | 28.9 |
| 18 | 2 | 24.1 |
| 18 | 4 | 23.3 |
| 18 | 6 | 19.3 |
| 18 | 8 | 19.2 |
| 18 | 10 | 23.1 |
| 18 | 12 | 29.1 |
| 18 | 14 | 37.2 |
| 18 | 16 | 43.2 |
| 18 | 18 | 43.5 |
| 18 | 20 | 36.9 |
| 18 | 22 | 33.1 |
| 18 | 24 | 34.9 |
| 18 | 26 | 40.2 |
| 18 | 28 | 62.5 |
| 18 | 30 | 125.0 |
| 20 | 0 | 26.7 |
| 20 | 2 | 22.6 |
| 20 | 4 | 22.5 |
| 20 | 6 | 19.7 |
| 20 | 8 | 20.7 |
| 20 | 10 | 25.1 |
| 20 | 12 | 30.1 |
| 20 | 14 | 36.3 |
| 20 | 16 | 42.5 |
| 20 | 18 | 44.6 |
| 20 | 20 | 41.2 |
| 20 | 22 | 37.6 |
| 20 | 24 | 38.2 |
| 20 | 26 | 40.8 |
| 20 | 28 | 72.1 |
| 20 | 30 | 174.0 |
| 22 | 0 | 27.4 |
| 22 | 2 | 22.4 |
| 22 | 4 | 23.1 |
| 22 | 6 | 22.2 |
| 22 | 8 | 24.5 |
| 22 | 10 | 28.3 |
| 22 | 12 | 31.2 |
| 22 | 14 | 35.1 |
| 22 | 16 | 41.4 |
| 22 | 18 | 46.2 |
| 22 | 20 | 46.0 |
| 22 | 22 | 43.8 |
| 22 | 24 | 43.0 |
| 22 | 26 | 44.5 |
| 22 | 28 | 95.7 |
| 24 | 0 | 32.1 |
| 24 | 2 | 24.1 |
| 24 | 4 | 24.9 |
| 24 | 6 | 27.5 |
| 24 | 8 | 30.2 |
| 24 | 10 | 32.4 |
| 24 | 12 | 33.2 |
| 24 | 14 | 34.4 |
| 24 | 16 | 40.4 |
| 24 | 18 | 48.1 |
| 24 | 20 | 51.1 |
| 24 | 22 | 49.4 |
| 24 | 24 | 45.5 |
| 24 | 26 | 50.6 |
| 24 | 28 | 133.9 |
| 26 | 0 | 38.7 |
| 26 | 2 | 27.9 |
| 26 | 4 | 29.8 |
| 26 | 6 | 33.5 |
| 26 | 8 | 35.2 |
| 26 | 10 | 37.1 |
| 26 | 12 | 36.7 |
| 26 | 14 | 35.8 |
| 26 | 16 | 40.7 |
| 26 | 18 | 50.3 |
| 26 | 20 | 55.3 |
| 26 | 22 | 52.1 |
| 26 | 24 | 43.9 |
| 26 | 26 | 58.7 |
| 28 | 0 | 44.4 |
| 28 | 2 | 32.8 |
| 28 | 4 | 36.4 |
| 28 | 6 | 39.6 |
| 28 | 8 | 37.3 |
| 28 | 10 | 38.7 |
| 28 | 12 | 41.2 |
| 28 | 14 | 39.7 |
| 28 | 16 | 42.0 |
| 28 | 18 | 51.4 |
| 28 | 20 | 56.2 |
| 28 | 22 | 49.7 |
| 28 | 24 | 45.1 |
| 28 | 26 | 84.2 |
| 30 | 0 | 46.8 |
| 30 | 2 | 39.5 |
| 30 | 4 | 45.8 |
| 30 | 6 | 44.8 |
| 30 | 8 | 36.7 |
| 30 | 10 | 38.9 |
| 30 | 12 | 46.0 |
| 30 | 14 | 44.7 |
| 30 | 16 | 43.0 |
| 30 | 18 | 49.3 |
| 30 | 20 | 52.7 |
| 30 | 22 | 54.4 |
| 30 | 24 | 84.3 |
| 32 | 0 | 47.2 |
| 32 | 2 | 48.3 |
| 32 | 4 | 57.2 |
| 32 | 6 | 52.1 |
| 32 | 8 | 38.2 |
| 32 | 10 | 42.9 |
| 32 | 12 | 53.7 |
| 32 | 14 | 52.2 |
| 32 | 16 | 46.8 |
| 32 | 18 | 54.6 |
| 32 | 20 | 74.5 |

TABLE 3

| χ (deg) | γ (deg) | RMS (μm) |
|---|---|---|
| 0 | 0 | 20.5 |
| 0 | 4 | 28.1 |
| 0 | 8 | 48.0 |
| 0 | 12 | 58.9 |
| 0 | 16 | 45.0 |
| 0 | 20 | 37.3 |
| 0 | 24 | 79.2 |
| 0 | 28 | 202.8 |
| 0 | 32 | 335.6 |
| 0 | 36 | 313.5 |
| 0 | 40 | 199.5 |
| 0 | 44 | 310.3 |
| 0 | 48 | 490.2 |
| 4 | 0 | 25.4 |
| 4 | 4 | 36.1 |
| 4 | 8 | 50.9 |
| 4 | 12 | 60.1 |
| 4 | 16 | 46.7 |
| 4 | 20 | 38.8 |
| 4 | 24 | 78.6 |
| 4 | 28 | 199.7 |
| 4 | 32 | 331.0 |
| 4 | 36 | 312.7 |
| 4 | 40 | 205.3 |
| 4 | 44 | 313.9 |
| 4 | 48 | 529.7 |
| 8 | 0 | 38.4 |
| 8 | 4 | 50.5 |
| 8 | 8 | 57.2 |
| 8 | 12 | 62.6 |
| 8 | 16 | 50.5 |
| 8 | 20 | 43.1 |
| 8 | 24 | 77.9 |
| 8 | 28 | 191.3 |
| 8 | 32 | 317.5 |
| 8 | 36 | 309.3 |
| 8 | 40 | 221.6 |
| 8 | 44 | 332.0 |
| 8 | 48 | 658.8 |
| 12 | 0 | 55.5 |
| 12 | 4 | 63.3 |
| 12 | 8 | 61.6 |
| 12 | 12 | 64.2 |
| 12 | 16 | 54.8 |
| 12 | 20 | 49.1 |
| 12 | 24 | 79.8 |
| 12 | 28 | 180.8 |
| 12 | 32 | 296.7 |
| 12 | 36 | 302.3 |
| 12 | 40 | 244.6 |
| 12 | 44 | 377.9 |
| 12 | 48 | 826.9 |
| 16 | 0 | 73.3 |
| 16 | 4 | 70.7 |
| 16 | 8 | 61.6 |
| 16 | 12 | 62.6 |
| 16 | 16 | 58.7 |
| 16 | 20 | 57.5 |
| 16 | 24 | 87.1 |
| 16 | 28 | 173.0 |
| 16 | 32 | 272.4 |
| 16 | 36 | 287.5 |
| 16 | 40 | 268.5 |
| 16 | 44 | 455.5 |
| 20 | 0 | 87.8 |
| 20 | 4 | 71.6 |
| 20 | 8 | 56.6 |
| 20 | 12 | 59.0 |
| 20 | 16 | 63.9 |
| 20 | 20 | 68.8 |
| 20 | 24 | 101.0 |
| 20 | 28 | 173.4 |
| 20 | 32 | 250.7 |
| 20 | 36 | 267.1 |
| 20 | 40 | 286.5 |
| 20 | 44 | 555.4 |
| 24 | 0 | 95.1 |
| 24 | 4 | 66.8 |
| 24 | 8 | 48.0 |
| 24 | 12 | 56.0 |
| 24 | 16 | 74.2 |
| 24 | 20 | 87.0 |
| 24 | 24 | 121.8 |
| 24 | 28 | 184.7 |
| 24 | 32 | 239.0 |
| 24 | 36 | 246.2 |
| 24 | 40 | 293.6 |
| 24 | 44 | 654.5 |
| 28 | 0 | 97.0 |
| 28 | 4 | 60.4 |
| 28 | 8 | 40.7 |
| 28 | 12 | 60.9 |
| 28 | 16 | 93.9 |
| 28 | 20 | 116.0 |
| 28 | 24 | 151.8 |
| 28 | 28 | 206.3 |
| 28 | 32 | 241.4 |
| 28 | 36 | 233.3 |
| 28 | 40 | 289.9 |
| 28 | 44 | 739.4 |
| 32 | 0 | 98.5 |
| 32 | 4 | 60.3 |
| 32 | 8 | 43.0 |
| 32 | 12 | 75.7 |
| 32 | 16 | 126.0 |
| 32 | 20 | 158.3 |
| 32 | 24 | 192.3 |
| 32 | 28 | 236.1 |
| 32 | 32 | 257.1 |
| 32 | 36 | 235.7 |
| 32 | 40 | 285.5 |
| 32 | 44 | 798.1 |
| 36 | 0 | 107.8 |
| 36 | 4 | 74.4 |
| 36 | 8 | 64.9 |
| 36 | 12 | 110.1 |
| 36 | 16 | 174.3 |
| 36 | 20 | 215.5 |
| 36 | 24 | 245.2 |
| 36 | 28 | 274.5 |
| 36 | 32 | 281.6 |
| 36 | 36 | 256.4 |
| 36 | 40 | 298.1 |
| 36 | 44 | 835.3 |
| 40 | 0 | 125.7 |
| 40 | 4 | 105.0 |
| 40 | 8 | 111.1 |
| 40 | 12 | 170.1 |
| 40 | 16 | 244.3 |
| 40 | 20 | 291.3 |
| 40 | 24 | 315.5 |
| 40 | 28 | 329.4 |
| 40 | 32 | 323.2 |
| 40 | 36 | 300.7 |
| 40 | 40 | 346.6 |
| 40 | 44 | 849.6 |
| 44 | 0 | 153.8 |
| 44 | 4 | 150.6 |
| 44 | 8 | 178.3 |
| 44 | 12 | 255.2 |
| 44 | 16 | 341.8 |
| 44 | 20 | 395.6 |
| 44 | 24 | 420.9 |
| 44 | 28 | 424.7 |
| 44 | 32 | 406.7 |
| 44 | 36 | 386.1 |
| 44 | 40 | 438.2 |
| 44 | 44 | 896.4 |
| 48 | 0 | 215.2 |
| 48 | 4 | 183.7 |
| 48 | 8 | 221.6 |
| 48 | 12 | 332.9 |
| 48 | 16 | 456.8 |
| 48 | 20 | 546.9 |
| 48 | 24 | 592.5 |
| 48 | 28 | 598.1 |
| 48 | 32 | 568.5 |
| 48 | 36 | 529.9 |
| 48 | 40 | 567.0 |
| 48 | 44 | 975.1 |
| 52 | 0 | 553.1 |
| 52 | 4 | 372.9 |
| 52 | 8 | 322.1 |
| 52 | 12 | 416.5 |
| 52 | 16 | 573.2 |
| 52 | 20 | 718.0 |
| 52 | 24 | 812.1 |
| 52 | 28 | 863.7 |
| 52 | 32 | 843.4 |
| 52 | 36 | 788.0 |
| 52 | 40 | 752.2 |
| 54 | 0 | 351.1 |
| 54 | 4 | 183.8 |
| 54 | 8 | 144.0 |
| 54 | 12 | 183.0 |
| 54 | 16 | 312.3 |
| 54 | 20 | 492.1 |
| 54 | 24 | 666.9 |
| 54 | 28 | 797.8 |
| 54 | 32 | 853.2 |
| 54 | 36 | 873.2 |
| 54 | 40 | 946.2 |

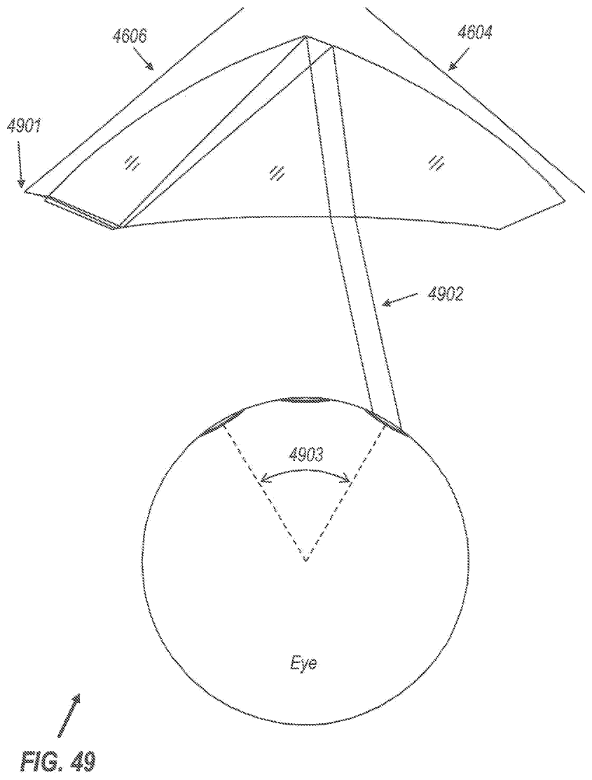

FIG. 49 shows the embodiment shown in FIG. 46. Rays 4902 emitted from edge 4901 of display 4606 define the extent of the pupil range 4903.

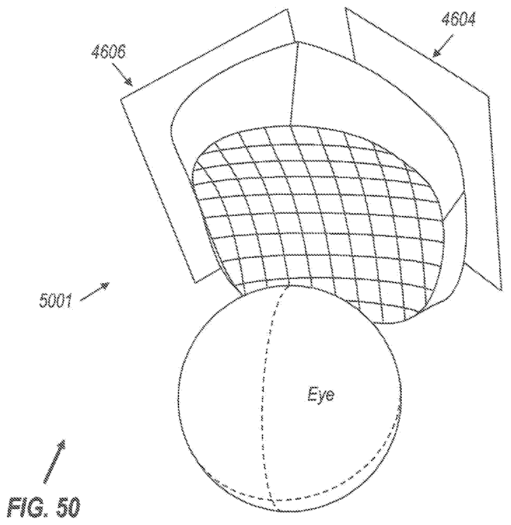

FIG. 50 shows a perspective view 5001 of embodiment shown in FIG. 46.

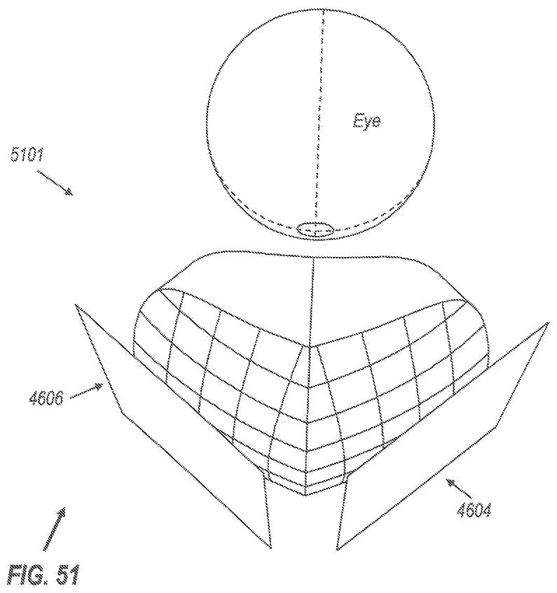

FIG. 51 shows a perspective view 5101 of embodiment shown in FIG. 46.

Calculation of the Retarder's Thickness and Rotation

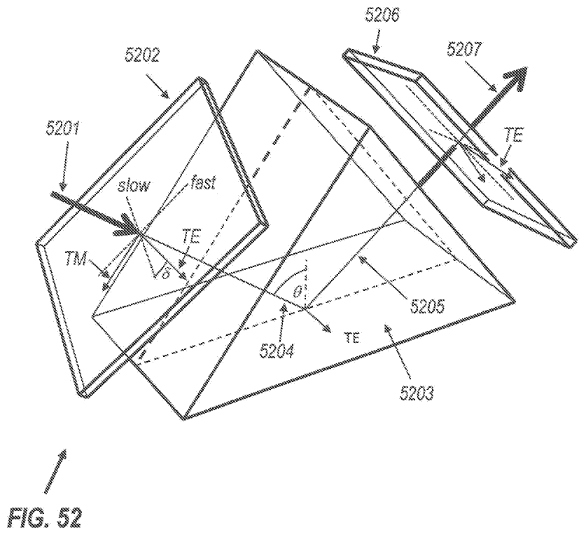

A horizontally linear polarizer light becomes vertical linear polarized after crossing two consecutive λ/4 retarders. This situation changes when the light suffers a Total Internal Reflection (TIR) between the retarders because the phase delay caused by the TIR is not the same for the 2 components of the field. This situation is sketched in FIG. 52.

Incident ray 5201 finds a retarder 5202 (a film made of a birefringent material, sometimes manufactured by stretching a polymer film), then a refractive prism 5203 where it suffers a TIR (sections 5204 and 5205 of the ray) and later leaves the prism to find an identical retarder 5206 after which the ray exist this configuration (section 5207 of the ray). The incidence of the ray on the two sides of the prism is a refraction so it doesn't induce a phase difference between the two components of the electric field.

The Electric vector is decomposed in a TE component which is normal to the incidence plane and the remaining component called TM. The fast and slow axes of the retarder are tilted with respect the TE and TM components of the vector field. In particular, the slow axis of the first retarder is rotated an angle δ with respect the axis TE (FIG. 52 is showing a case for small positive δ angle). The second retarder is configured so a symmetric ray going from 5207 to 5201 finds the same structure as the ray going from 5201 to 5207. This means that the second retarder is rotated an angle −δ with respect the axis TE when going from 5205 to 5207.

In order to calculate the polarization state (Jones vector) at the output 5207 with respect the polarization state at the input 5201, we need to calculate the global Jones matrix M which is simply the multiplication of the Jones matrices of the 3 components: 2 tilted retarders and a TIR.

$$( \begin{matrix}{E}_{TE 4} \\ {E}_{TM 4}\end{matrix} ) = ( \begin{matrix}{m}_{11} & {m}_{12} \\ {m}_{21} & {m}_{22}\end{matrix} ) ( \begin{matrix}{E}_{TE 1} \\ {E}_{TM 1}\end{matrix} ) \qquad ( 1 )$$

The calculation of the tilted retarder matrices is simply by using the rotation matrix R(δ):

$$R ( δ ) = ( \begin{matrix}cos δ & - sin δ \\ sin δ & cos δ\end{matrix} ) \qquad ( 2 )$$

Matrix R(δ) is henceforth called R₊, while its inverse (i.e., R(−δ)) is called R. The Jones matrix of a non-rotated retarder is Γ:

$$Γ = A ( \begin{matrix}{e}^{il} & 0 \\ 0 & 1\end{matrix} ) \qquad ( 3 )$$

Where the phase Γ=2π(n_{slow}−n_{fast})L/λ₀, n_{slow} and n_{fast} are the two refractive indices of the birefringent material, L is the film thickness and λ₀ is the wavelength in vacuum.

The Jones matrix for the TIR can be written as

$$T = ( \begin{matrix}{r}_{TE} & 0 \\ 0 & {r}_{TM}\end{matrix} ) \qquad ( 4 )$$

where r_{TE} and r_{TM} are the Fresnel reflection coefficients

$$\begin{matrix}{r}_{TE} = \frac{{n}_{i} cos {θ}_{i} - {in}_{i} \sqrt{{( {n}_{i} sin {θ}_{i} / {n}_{t} )}^{2} - 1}}{{n}_{i} cos {θ}_{i} + {in}_{i} \sqrt{{( {n}_{i} sin {θ}_{i} / {n}_{t} )}^{2} - 1}} = {e}^{i {φ}_{TE}} & ( 5 ) \\ {r}_{TM} = \frac{- {n}_{i} cos {θ}_{i} + {in}_{i} \sqrt{{( {n}_{i} sin {θ}_{i} / {n}_{t} )}^{2} - 1}}{{n}_{i} cos {θ}_{i} + {in}_{i} \sqrt{{( {n}_{i} sin {θ}_{i} / {n}_{t} )}^{2} - 1}} = {e}^{i {φ}_{TM}} & ( 6 ) \\ Then & \\ T = ( \begin{matrix}{e}^{i {φ}_{TE}} & 0 \\ 0 & {e}^{i {φ}_{TM}}\end{matrix} ) & ( 7 )\end{matrix}$$

The following equations relate the Jones vectors before and after each one of the components:

$$\begin{matrix}( \begin{matrix}{E}_{TE 2} \\ {E}_{TM 2}\end{matrix} ) = ( {R}_{-} Γ {R}_{+} ) ( \begin{matrix}{E}_{TE 1} \\ {E}_{TM 1}\end{matrix} ) \vert ( \begin{matrix}{E}_{TE 3} \\ {E}_{TM 3}\end{matrix} ) = T ( \begin{matrix}{E}_{TE 2} \\ {E}_{TM 2}\end{matrix} ) \vert ( \begin{matrix}{E}_{TE 4} \\ {E}_{TM 4}\end{matrix} ) = ( {R}_{+} Γ {R}_{-} ) ( \begin{matrix}{E}_{TE 3} \\ {E}_{TM 3}\end{matrix} ) & ( 8 ) \\ Then & \\ M = ( {R}_{+} Γ R ) T ( {R}_{-} Γ {R}_{+} ) & ( 9 )\end{matrix}$$

If E_{TE4}=0 when E_{TM1}=0, then necessarily m₁₁=0. Since m₁₁ is a complex number this last equation contains 2 scalar equations. In this situation, the output field has only TM component and value is E_{TM4}=m₂₁E_{TE1}.

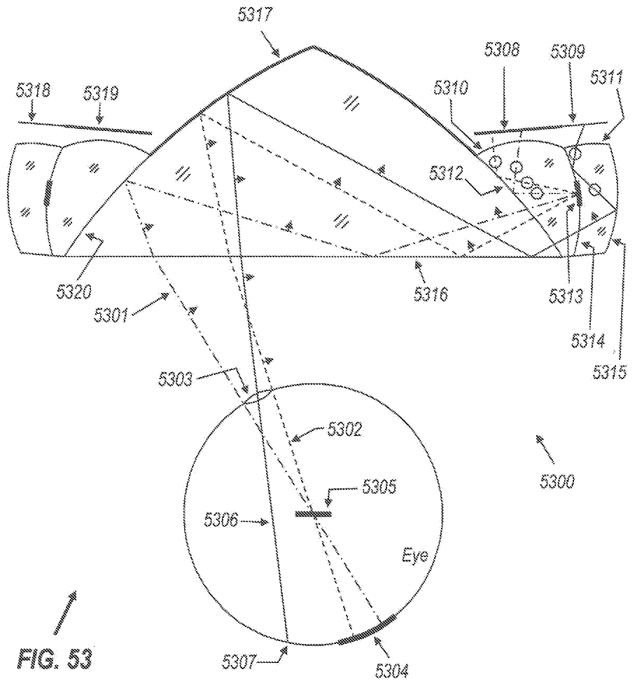

FIG. 53 shows a configuration that shares similarities with the configuration in FIG. 29, but that separates the rays that reach the fovea from the remaining rays that reach the retina outside the fovea. Rays 5301 and 5302 cross the eye pupil 5303 reaching the fovea 5304. These rays also cross a pupil 5305 at the center of the eye. As the eye pupil 5303 rotates around the center of the eye, so does the fovea 5304 and the rays reaching the fovea still cross pupil 5305. Since the human eye has a high resolution at the fovea, these rays should preferably also have high resolution. Other rays such as ray 5306 crossing the eye pupil 5303 at wider angles do not cross pupil 5305 and reach the retina at positions 5307 outside the fovea. Outside the fovea the human eye has a lower resolution and these rays may have a lower resolution.

Crossing or not crossing pupil 5305 at the center of the eye may then be taken as a criterion for separating high resolution rays reaching the fovea from low resolution rays that reach the retina outside the fovea.

Optic 5300 is composed of several elements. Displays 5308 and 5309 emit polarized light. In this illustration, light emitted by said displays is polarized in the direction perpendicular to the plane of the figure (perpendicular polarization). Said displays may be two separate components or two sections of one single display. Displays 5318 and 5319 also emit polarized light, but with a polarization perpendicular to that of displays 5308 and 5309. In this exemplary configuration, light emitted by displays 5318 and 5319 is polarized on the plane of the figure (parallel polarization). Surfaces 5312 and 5314 are light filters that are substantially transmissive to parallel polarization and substantially reflective to perpendicular polarization. Surface 5320 is a light filter that is substantially transmissive to perpendicular polarization and substantially reflective to parallel polarization. Surface 5313 is mirrored and contains a ¼ wavelength retarder to the left of it. Surfaces 5315 is also mirrored and also contains a mirror and a ¼ wavelength retarder to the left of it. Surface 5317 is mirrored.

Exemplary light rays 5301 and 5302 emitted from display 5308 have perpendicular polarization. These rays are refracted into optic 5300 through its surface 5310 and are reflected at light filter 5312. Said rays then reach element 5313 crossing the ¼ wavelength retarder, reflecting at the mirror behind it and crossing again said retarder, emerging with their polarization rotated by 90°, which is now parallel. Said rays now cross light filter 5312, suffer TIR at bottom surface 5316, are reflected either at mirror 5317 or light filter 5320, and refract out of optic 5300 through its bottom surface 5316. Said rays then enter the eye through eye pupil 5303, cross pupil 5305 at the center of the eye and reach the fovea 5304 at the back of the eye.

Another exemplary ray 5306 emitted from display 5309 has perpendicular polarization. Said ray is refracted into optic 5300 through its surface 5311 and is reflected either at light filter 5314 or mirror 5313. Said ray then reaches element 5315 crossing the ¼ wavelength retarder, reflecting at the mirror behind it and crossing again said retarder, emerging with its polarization rotated by 90°, which is now parallel. Said ray now crosses light filters 5314 and 5312, suffers TIR at bottom surface 5316, is reflected either at mirror 5317 or light filter 5320, and refract out of optic 5300 through its bottom surface 5316. Said ray then enters the eye through eye pupil 5303, does not cross pupil 5305 at the center of the eye and reaches the retina at position 5307 outside the fovea 5304 at the back of the eye.

Optic 5300, which has similarities to the optic shown in FIG. 29, forms an image of pupil 5305 on element 5313. Considering then light travelling in the reverse direction from the eye towards optic 5300, rays crossing pupil 5305 will reach its image at 5313 being reflected there. Eventually these rays will reach display 5308. That is the case of rays 5301 and 5302, if travelling in the reverse direction. However, reverse rays crossing eye pupil 5303 but not pupil 5305 will miss element 5313 and will move along the optic through a different channel towards display 5309. That is the case of ray 5306 if moving in the reverse direction.

As referred above, rays 5301 and 5302 reaching the fovea need a high resolution and, for that reason, the channel starting at surface 5310 that captures light from display 5308 preferably has a larger focal distance. Also, rays such as 5306 that do not reach the fovea do not need a high resolution and, for that reason, the channel starting at surface 5311 that captures light from display 5309 preferably has a shorter focal distance.

Optical surfaces on the left side of optic 5300 have symmetrical properties relative to those on the right side, similarly to what is disclosed in FIG. 29. Accordingly, light rays travelling through the left side have polarizations which are perpendicular to those of the corresponding rays on the right side.

In a different configuration, element 5313 and light filter 5314 are apart from each other, preferably having element 5313 to the left of light filter 5314 (and a symmetrical configuration on the left side of optic 5300).

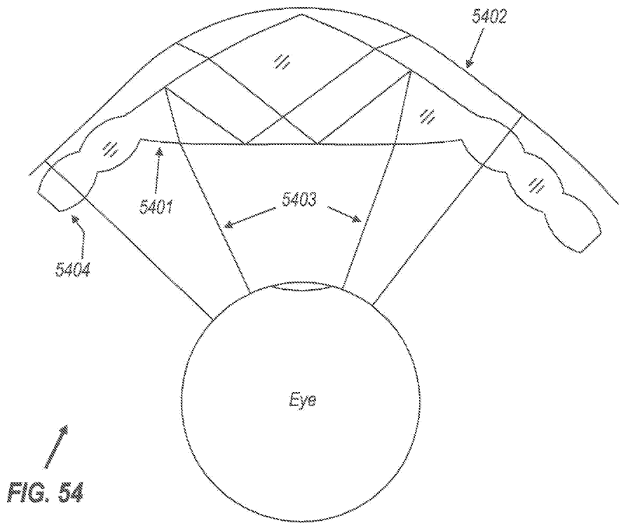

FIG. 54 shows an optic 5401 similar to that in FIG. 7 designed for a curved display 5402. Also shown are some exemplary rays 5403. An array of microlenses 5404 widens the field of view of the system. Said lenses may have a short focal length resulting in low resolution, matching the low resolution of the eye at wide angles. This embodiment allows for a wider range mechanical adjustment of the interpupillary distance (IPD). In another embodiment, this optic may be used with two separate displays (preferably flat) instead of a single, curved one.

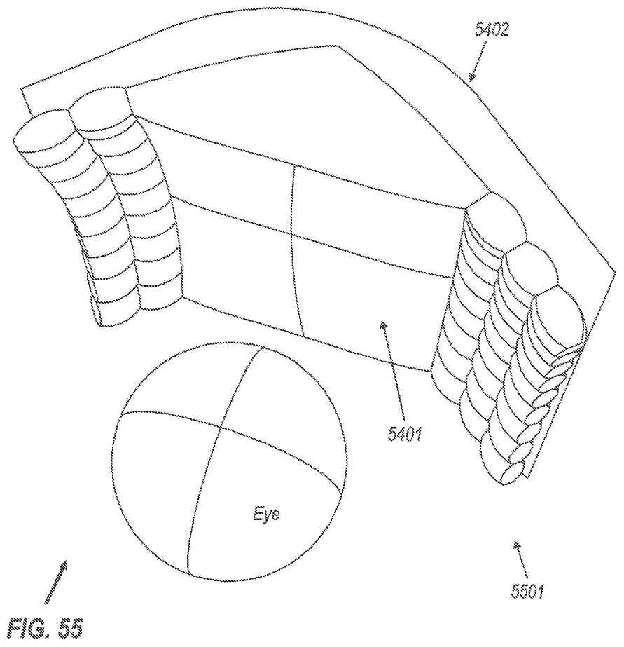

FIG. 55 shows configuration 5501, the same configuration as in FIG. 54, but now in a three-dimensional view. Curved display 5402 has linear symmetry and may be obtained by bending a flat display. Optic 5401 is free-form.

In a preferred embodiment the FOV is asymmetric horizontally (larger in the outboard direction, and smaller in the nasal-inboard direction). The number of microlenses may also be different for both sides of optic 5401.

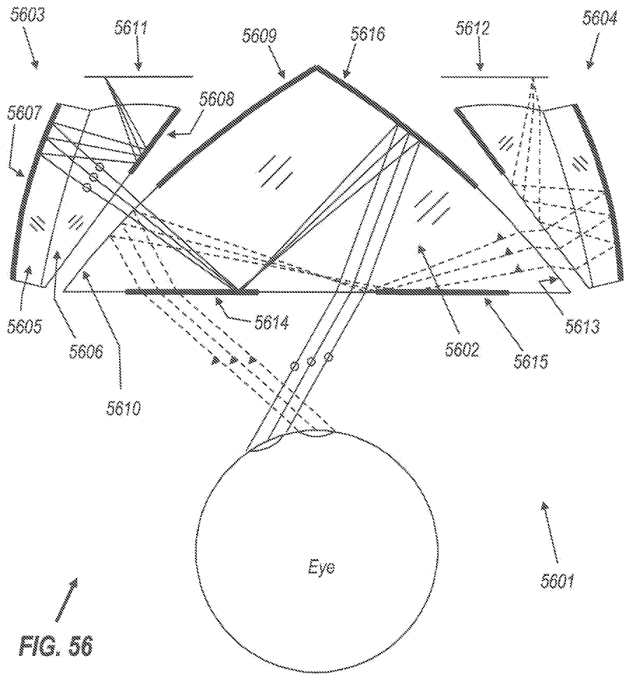

FIG. 56 shows a cross section of a preferred embodiment 5601 composed of central main optic 5602 made of transparent material and side projectors 5603 and 5604.

Surface 5610 of the central optic is a light filter that is substantially transmissive to the light emitted by display 5611 and substantially reflective to the light emitted by display 5612. Surface 5613 is a light filter that is substantially transmissive to the light emitted by display 5612 and substantially reflective to the light emitted by display 5611.

In one embodiment surface 5614 is substantially transmissive to the light emitted from display 5612 and substantially reflective to the light emitted from display 5611. This will prevent failing TIR of light emitted from display 5611. Also, surface 5615 is substantially transmissive to the light emitted from display 5611 and substantially reflective to the light emitted from display 5612. This will prevent failing TIR of light emitted from display 5612.

In another embodiment surface 5614 is substantially transmissive to the light emitted from display 5612 and substantially absorptive to the light emitted from display 5611. This will prevent stray light emitted from display 5611 to reach the eye. Also, surface 5615 is substantially transmissive to the light emitted from display 5611 and substantially absorptive to the light emitted from display 5612. This will prevent stray light emitted from display 5612 to reach the eye.

Main optic 5602 may have portions of its surfaces mirrored, such as 5609 or 5616. In another embodiment, surface 5609 may be a light filter similar to 5610 and surface 5616 may be a light filter similar to 5613.

Side projector 5603 may be a doublet composed of two parts 5605 and 5606 made of different refractive index materials for correcting chromatic aberration. Side projector 5603 may also have mirrored surfaces such as 5607 or 5608 to prevent failing TIR at some of its surfaces. Side projector 5604 has a similar but substantially symmetrical configuration.

In another embodiment, projector 5603 may be one single part and said correction of chromatic aberration may be achieved by using diffractive surfaces. Again, side projector 5604 has a similar but substantially symmetrical configuration.

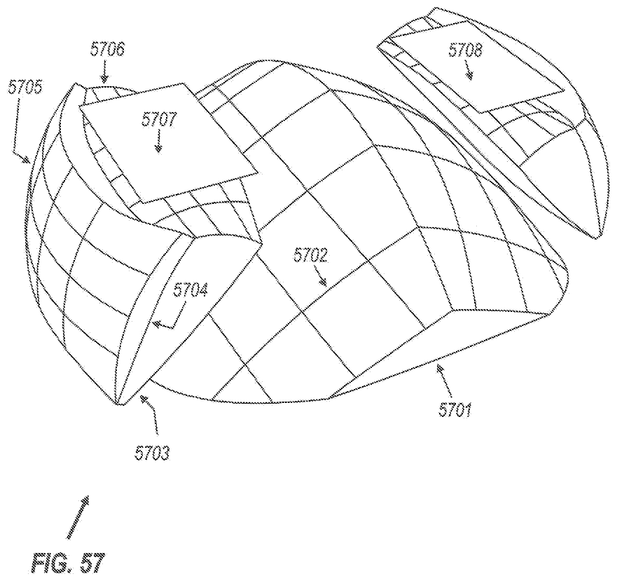

FIG. 57 shows a three-dimensional view of an embodiment similar to that shown in FIG. 56. Optically active surfaces 5701, through 5706 are free-form. The embodiment is fundamentally left-right symmetrical in the optical functions of its optical components. Also shown are displays 5707 and 5708.

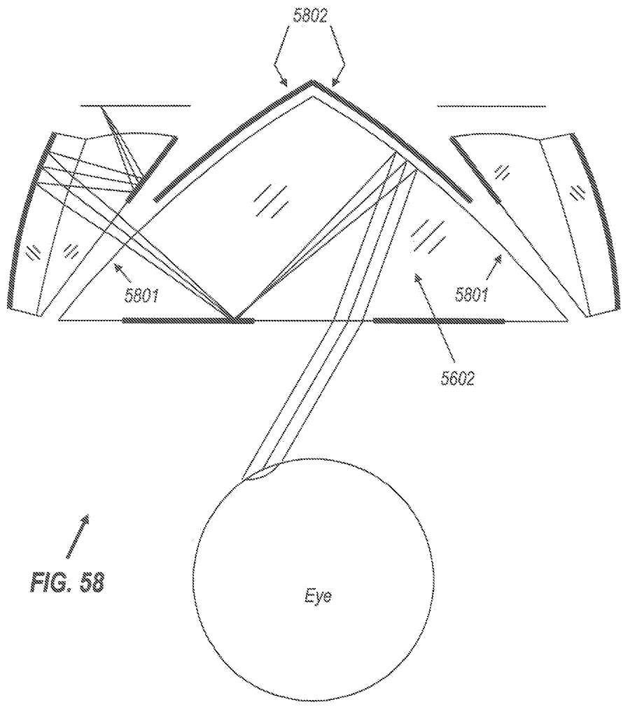

FIG. 58 shows the cross section of an embodiment similar to that in FIG. 56. In this embodiment, surface 5801 of central main optic 5602 is a semitransparent mirror whose reflectivity and transmission may vary across its surface. Also included is element 5802 that absorbs light. This configuration may be used with high birefringence materials since its working principle do not depend on the polarization of the light.

Absorbing element 5802 should be optically coupled to the central main optic 5602 to prevent the TIR at wide incidence angles.

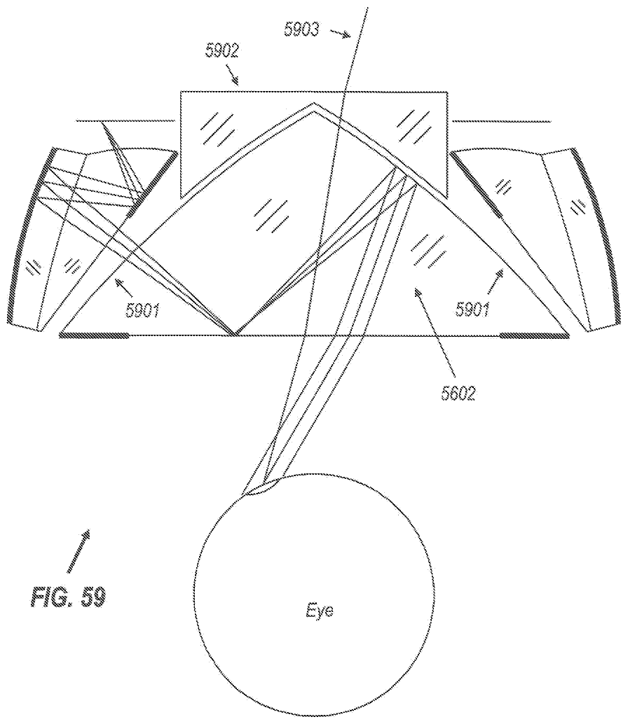

FIG. 59 shows a similar configuration to that in FIG. 58. Surfaces 5901 are semitransparent mirrors. Additional element 5902 corrects the distortion introduced by central main optic 5602 allowing the eye to see the outside world in a see-through configuration, as illustrated by incoming ray 5903. In general, the optical surfaces of element 5903 are free-form, just like all optically active surfaces in this embodiment. This was also the case in a related configuration in FIG. 25.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed. The various embodiments and elements can be interchanged or combined in any suitable manner as necessary.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

Although specific embodiments have been described, the preceding description of presently contemplated modes of practicing the invention is not to be taken in a limiting sense, but is made merely for the purpose of describing certain general principles of the invention. Variations are possible from the specific embodiments described. For example, the patents and applications cross-referenced above describe systems and methods that may advantageously be combined with the teachings of the present application. Although specific embodiments have been described, the skilled person will understand how features of different embodiments may be combined.

The full scope of the invention should be determined with reference to the claims, and features of any two or more of the claims may be combined.

1. A display device comprising:
one or more displays, operable to generate a real image comprising a plurality of object pixels; and
an optical system, comprising a plurality of channels arranged to generate an immersive virtual image from the real image, the immersive virtual image comprising a plurality of image pixels, by each channel projecting light from the object pixels to a respective pupil range;
wherein the pupil range comprises an area on the surface of an imaginary sphere of from 21 to 27 mm diameter, the pupil range including a circle subtending 15 degrees whole angle at the center of the sphere;
wherein the object pixels are grouped into clusters, each cluster associated with a channel, so that the channel produces from the object pixels a partial virtual image comprising image pixels, and the partial virtual images combine to form said immersive virtual image;
wherein imaging light rays falling on said pupil range through a given channel come from pixels of the associated cluster, and said imaging light rays falling on said pupil range from object pixels of a given cluster pass through the associated channel;
wherein said imaging light rays exiting a given channel towards the pupil range and virtually coming from any one image pixel of the immersive virtual image are generated from a single object pixel of the associated cluster;
wherein the clusters of at least two channels are substantially contained in opposite half-spaces defined by a plane passing by the imaginary sphere center;
wherein each one of said two channels comprises one surface on which the imaging light rays forming the partial virtual image suffer a last reflection before reaching the pupil range; and
wherein each one surface of said two channels is substantially contained in the opposite half-space containing their respective clusters.

2. A display device according to claim 1, wherein all the object pixels belong to a single display.

3. A display device according to claim 1, in which at least a display surface is partially cylindrical in shape.

4. A display device according to claim 1, in which at least a display surface is curved.

5. A display device according to claim 1, wherein all the object pixels belong to a two flat displays.

6. A display device according to claim 1, in which at least one surface is configured to transmit the rays of one of the two channels and reflect the rays of the other channel of the two channels.

7. A display device according to claim 1, further comprising a common optical surface where all the imaging light rays of both two channels are refracted.

8. A display device according to claim 7, wherein all the imaging rays of both two channels are also reflected on said common optical surface.

9. A display device according to claim 8, wherein said reflection is total internal.

10. A display device according to claim 8, wherein said reflection is achieved by a light filter.

11. A display device according to claim 10, wherein said light filter is flat.

12. A display device according to claim 10, wherein said light filter is a reflective polarizer, a dichroic filter, angular-selective transparent filler or a semitransparent mirror.

13. A display device according to claim 6, wherein the last reflecting surfaces of the two channels and their common optical surface are three faces of a solid dielectric piece of material.

14. A display device according to claim 1, wherein a portion of said each last reflecting surface also permits transmission of imaging light rays.

15. A display device according to claim 14, wherein the transmission and reflection of said surface is achieved by a light filter.

16. A display device according to claim 15, wherein said light filter is a reflective polarizer, a dichroic filter, angular-selective transparent filter or a semitransparent mirror.

17. A display device according to claim 1, wherein the last reflecting surface of at least each one of the two channels is a surface of a thin sheet of material.

18. A display device according to claim 1, wherein the last reflecting surfaces of the two channels are semitransparent to allow for see-through visualization.

19. A display device according to claim 1, wherein absorbing or reflecting surfaces are added to eliminate the creation of ghost images.

20. A display device according to claim 13, wherein a refractive corrector element is added for see-though visualization.

21. A display device according to claim 1, wherein a reflecting surface of the two channels comprises a stack of spaced reflectors to reduce the convergence accommodation-mismatch.

22. A display device according to claim 1, wherein the displays are directional emitting light within a solid angle which is smaller than the full hemisphere.

23. A display device according to claim 22, wherein the directionality is made using angular-selective transparent filter on top the display.

24. A display device according to claim 1, wherein at least one of the display's is a light field display.

25. A display device according to claim 1, wherein at least one of the two channels is an optical system with either (i) a positive magnification, (ii) a negative magnification, or (iii) a positive magnification in one direction and negative magnification in a substantially perpendicular direction.

26. A display device according to claim 1, wherein the two channels substantially contained in opposite half-spaces form the partial virtual images in the central part of the field of view and other channels form partial virtual images of the peripheral part of the field of view.

27. A display device according to claim 1, further comprising a mounting fixture operative to maintain the device in a substantially constant position relative to a normal human head with one eye at the position of the imaginary sphere.

28. A display device according to claim 1, wherein the optical system is arranged to produce partial virtual images at least one of which contains a part projected by a human eye onto a 1.5 mm fovea of said eye when said eye is at the eye position with its pupil within a pupil range, said part of said partial virtual image having a higher resolution than when projected on a peripheral part of the retina of said eye when said eye is at a different eye position with its pupil within a pupil range.

29. A display device according to claim 28, wherein the rays that form the partial virtual images on the fovea are emitted from different cluster than the rays that form the partial virtual images on a peripheral part of the retina of said eye.

30. A display device according to claim 1, wherein the pixels of the virtual image are more dense at the center of the field of view than at the outer region of the field of view.
